(19) United States
(12) Patent Application Publication
(10) Pub. No.: US 2024/0313517 A1
(43) Pub. Date: Sep. 19, 2024

(54) ZIPLINE WITH TEXTURED ROLLERS FOR PANEL WIRE MANAGEMENT

(71) Applicant: Easy Solar Products, Inc., Holladay, UT (US)

(72) Inventors: Brady Schimpf, Eagle Point, OR (US); Brady Hoddinott, New Hartford, CT (US); Benjamin Wade, Holladay, UT (US); Alexander Bornemann, Duxbury, VT (US)

(21) Appl. No.: 18/384,199

(22) Filed: Oct. 26, 2023

Related U.S. Application Data
(63) Continuation-in-part of application No. 18/120,630, filed on Mar. 13, 2023.

(51) Int. Cl. H02G 11/00; H02S 40/30

(52) U.S. Cl. CPC H02G 11/006; H02S 40/30

(57) ABSTRACT

An apparatus with rollers for a zip line wire management system includes a mounting clip that includes an outer clip and an inner clip. The outer clip and inner clip are operable to clamp onto a frame. The apparatus includes a locking mechanism within the mounting clip configured to resist movement of a spanning member extending through the mounting clip in a first direction and to allow movement of the spanning member in a second direction opposite the first direction. The locking mechanism includes one or more rollers configured to wedge against the spanning member moving in the first direction.

### CROSS-REFERENCES TO RELATED APPLICATIONS

This is a continuation-in-part application of and claims priority to U.S. patent application Ser. No. 18/120,630 entitled “ZIP LINE FOR PANEL WIRE MANAGEMENT” and filed on Mar. 13, 2023, for Brady Schimpf, et al., which is incorporated herein by reference.

### FIELD

This invention relates to wire management and more particularly relates to a zip line wire management system for wiring from electrical panels, such as solar panels.

### BACKGROUND

Electrical panels, such as solar panels, typically include wiring to connect the panels. Often the panels include a junction box with one or more wires extending from the junction boxes that connect to other wires, connect to other panels, connect to other devices, etc. Where the panels are solar panels, often the wires are mounted under the solar panels in a space between the solar panels and a roof as well as space between the solar panels and structural supports, all of which is often abrasive. Wires drooping too low and exposed to wind and other weather often cause the wires to rub against the roof, which damages the wires. The panels may also be ground mounted where drooping cables are also subject to wear. In addition, drooping wires is unsightly and undesirable.

### SUMMARY

An apparatus for a zip line wire management system is disclosed. The apparatus includes a first mounting clip and a second mounting clip. The first and second mounting clips are configured to connect to a frame of a panel. The first mounting clip includes a first spanning member connection point and the second mounting clip includes a second spanning member connection point. The apparatus includes a spanning member configured to connect between the first spanning member connection point and the second spanning member connection point. The apparatus includes at least one tensioner configured to provide tension to the spanning member while the spanning member is connected between the first mounting clip and the second mounting clip. The spanning member is configured to support a wire of the panel.

Another apparatus for a zip line wire management system includes a first spanning member connection point and a second spanning member connection point. The first and second spanning member connection points are each configured to be positioned on a frame of a panel. The apparatus includes a spanning member configured to connect between the first spanning member connection point and the second spanning member connection point and at least one tensioner configured to provide tension to the spanning member while the spanning member is connected between the first spanning member connection point and the second spanning member connection point. The spanning member is configured to support a wire of the panel.

Another apparatus for a zip line wire management system includes a first mounting clip and a second mounting clip. The first and second mounting clips are configured to connect to a frame of a panel. The first mounting clip includes a first spanning member connection point and the second mounting clip includes a second spanning member connection point. The apparatus includes a spanning member configured to connect between the first spanning member connection point and the second spanning member connection point and at least one tensioner configured to provide tension to the spanning member while the spanning member is connected between the first mounting clip and the second mounting clip. The spanning member is configured to support a wire of the panel. The spanning member includes a cable stop at a first end of the spanning member and a tensioner of the at least one tensioner at a second end of the spanning member or the at least one tensioner includes a first tensioner on the spanning member at the first end of the spanning member and a second tensioner on the spanning member at the second end of the spanning member.

In some embodiments, the cable stop positioned on a side of the first mounting clip opposite a center section between the first and second mounting clips is configured to prevent the spanning member from being pulled through the first spanning member connection point resulting from a force applied to the spanning member toward the center section. In other embodiments, the first tensioner and/or the second tensioner each include a locking mechanism positioned on a side of the first or second spanning member connection point opposite the center section and configured to resist movement of the spanning member in a first direction toward the center section and configured to allow movement of the spanning member in a second direction opposite the first direction. Applying a force on the spanning member on an end of the spanning member with a tensioner in the second direction provides tension to the spanning member.

Another apparatus with rollers for a zip line wire management system includes a mounting clip that includes an outer clip and an inner clip. The outer clip and inner clip are operable to clamp onto a frame. The apparatus includes a locking mechanism within the mounting clip configured to resist movement of a spanning member extending through the mounting clip in a first direction and to allow movement of the spanning member in a second direction opposite the first direction. The locking mechanism includes one or more rollers configured to wedge against the spanning member moving in the first direction.

A system for wire management of a frame includes a first mounting clip, a second mounting clip, and a spanning member positioned between the first mounting clip and the second mounting clip. Each mounting clip includes an outer clip, an inner clip, and a locking mechanism. The outer clip and inner clip of the first mounting clip are operable to clamp onto a first side of a frame and the outer clip and inner clip of the second mounting clip are operable to clamp onto a second side of the frame. The locking mechanism within each mounting clip is configured to resist movement of the spanning member extending through the mounting clip in a first direction towards the inner clip of the mounting clip and to allow movement of the spanning member in a second direction opposite the first direction. The locking mechanism includes one or more textured rollers configured to wedge against the spanning member moving in the first direction. The first mounting clip and the second mounting clip are positionable on the frame to tighten the spanning member between the first mounting clip and second mounting clip.

Another apparatus for wire management of a frame includes a mounting clip with an outer clip and an inner clip. The outer clip and inner clip are operable to clamp onto a frame. The frame includes a horizontal portion and a vertical portion coupled to the horizontal portion. The inner clip includes a frame clip configured to engage an edge of the horizontal portion of the frame and the outer clip includes a frame stop configured to engage the vertical portion of the frame. Sliding the outer clip towards the inner clip with the frame clip over the horizontal portion of the frame and the frame stop against the vertical portion of the frame secures the mounting clip to the frame. Each outer clip includes locking teeth and the locking teeth are arranged in a row in a direction that the outer clip slides through the inner clip. Each inner clip includes opposing teeth positioned to mate with the locking teeth and to oppose sliding the outer clip away from the inner clip. The apparatus includes a cable and a locking mechanism within each mounting clip configured to resist movement of the cable extending through the mounting clip in a first direction and to allow movement of the cable in a second direction opposite the first direction. The locking mechanism includes a roller compartment with two textured rollers positioned on either side of the cable configured to wedge against the cable moving in the first direction. The roller compartment includes an angled side adjacent to each of the two textured rollers. The angled sides are angled to narrow in a direction towards the inner clip in the second direction. An angle of each of the angled sides is in a range of 10 degrees to 35 degrees.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side section view illustrating a panel with a zip line wire management system with a first type of mounting clips, according to various embodiments;

FIG. 1B is a side section view illustrating a panel with a zip line wire management system with a second type of mounting clips, according to various embodiments;

FIG. 2A is a perspective view illustrating a panel with a spanning member connected between openings of a panel frame, according to various embodiments;

FIG. 2B is a close-up view of an end of the spanning member of FIG. 2A illustrating a tensioner in the form of a spring, according to various embodiments;

FIG. 3A is a perspective view illustrating a panel with a first spanning member connected between openings of a panel frame and a second spanning member connected between an opening in the frame and the first spanning member, according to various embodiments;

FIG. 3B is a close-up view of a connection between the first spanning member and the second spanning member of FIG. 3A, according to various embodiments;

FIG. 4A is a perspective view illustrating a panel with a first spanning member with a spring section connected between openings of a panel frame and a second spanning member with a spring section connected between an opening in the frame and the first spanning member, according to various embodiments;

FIG. 4B is a close-up view of a connection between the first spanning member and the second spanning member of FIG. 4A, according to various embodiments;

FIG. 5A is a perspective view illustrating a mounting clip with a spanning member connection point and slack management slot, according to various embodiments;

FIG. 5B is a side view of the mounting clip of FIG. 5A;

FIG. 5C is a first end view of the mounting clip of FIG. 5A;

FIG. 5D is a second end view of the mounting clip of FIG. 5A;

FIG. 6A is a perspective view illustrating a panel with a spanning member connected between a mounting clips similar to the mounting clip of FIGS. 5A-5D that are connected to a panel frame, according to various embodiments;

FIG. 6B is a close-up view of a first mounting clip of FIG. 6A connected to the frame, according to various embodiments;

FIG. 6C is a close-up view of a second mounting clip of FIG. 6A connected to the frame, according to various embodiments;

FIG. 6D is a close-up side section view of the second mounting clip of FIG. 6A connected to the frame, according to various embodiments;

FIG. 7 is a side view of an illustration of a spanning member with a wire wrapped around the spanning member, according to various embodiments;

FIG. 8 is a perspective view of a single hole tensioner and two views of a double-hole tensioner, according to various embodiments;

FIG. 9A is a perspective view of another mounting clip configured to mount to a frame of a panel, according to various embodiments;

FIG. 9B is a top view of the mounting clip of FIG. 9A, according to various embodiments;

FIG. 9C is a side view of the mounting clip of FIG. 9A, according to various embodiments;

FIG. 9D is an end view of the mounting clip of FIG. 9A, according to various embodiments;

FIG. 10 is a partial bottom perspective view of a panel frame with a spanning member connected to a three-hole tensioner with a wire support loop supporting a wire, according to various embodiments;

FIG. 11 is a partial perspective top view of a panel frame with two spanning members connected to a three-hole tensioner with a wire support loop supporting a wire, according to various embodiments;

FIG. 12 is a partial perspective top view of a panel frame with a spanning member shaped as a wire hanger supporting a wire, according to various embodiments;

FIG. 13A is a perspective view of a mounting clip for securing a spanning member to a frame of a panel, according to various embodiments;

FIG. 13B is a side view of the mounting clip of FIG. 13A, according to various embodiments;

FIG. 13C is an exploded perspective view of the mounting clip of FIG. 13A, according to various embodiments;

FIG. 13D is a perspective view of the partially assembled mounting clip of FIG. 13A, according to various embodiments;

FIG. 13E is a top view of the partially assembled mounting clip of FIG. 13A, according to various embodiments;

FIG. 13F is a side view of the mounting clip of FIG. 13A, according to various embodiments;

FIG. 14A is a perspective view of an inner clip of the mounting clip of FIG. 13A, according to various embodiments;

FIG. 14B is a top view of the inner clip of FIG. 14A, according to various embodiments;

FIG. 14C is a bottom view of the inner clip of FIG. 14A, according to various embodiments;

FIG. 14D is a front view of the inner clip of FIG. 14A, according to various embodiments;

FIG. 14E is a rear view of the inner clip of FIG. 14A, according to various embodiments;

FIG. 14F is a side view of the inner clip of FIG. 14A, according to various embodiments;

FIG. 14G is a front view of the inner clip of FIG. 14A with an outer clip, according to various embodiments;

FIG. 15A is a perspective view of the outer clip of the mounting clip of FIG. 13A, according to various embodiments;

FIG. 15B is a top view of the outer clip of FIG. 15A, according to various embodiments;

FIG. 15C is a bottom view of the outer clip of FIG. 15A, according to various embodiments;

FIG. 15D is a front view of the outer clip of FIG. 15A, according to various embodiments;

FIG. 15E is a rear view of the outer clip of FIG. 15A, according to various embodiments;

FIG. 15F is a side view of the outer clip of FIG. 15A, according to various embodiments;

FIG. 16A is a bottom view of an electrical panel with two mounting clips of FIG. 13A and a spanning member in between, according to various embodiments;

FIG. 16B is a bottom perspective view of the electrical panel of FIG. 16A with the two mounting clips of FIG. 13A and the spanning member in between, according to various embodiments;

FIG. 16C is a partial bottom view of the electrical panel of FIG. 16A with one of the two mounting clips of FIG. 13A and the spanning member, according to various embodiments;

FIG. 16D is a partial side view of the electrical panel of FIG. 16A with one of the two mounting clips of FIG. 13A and the spanning member, according to various embodiments;

FIG. 16E is a partial perspective view of the electrical panel of FIG. 16A with one of the two mounting clips of FIG. 13A and the spanning member, according to various embodiments;

FIG. 16F is a bottom view of an electrical panel with two mounting clips of FIG. 13A, top and bottom, and a spanning member in between, according to various embodiments;

FIG. 17A is a side view of the mounting clip of FIG. 13A mounted on a frame of a panel, according to various embodiments;

FIG. 17B is a bottom perspective view of the mounting clip of FIG. 13A mounted on a frame of a panel, according to various embodiments;

FIG. 17C is a side section view of the mounting clip of FIG. 13A mounted on a frame of a panel, according to various embodiments;

FIG. 18A is a perspective view of the mounting clip of FIG. 13A and a release tool prior to insertion, according to various embodiments;

FIG. 18B is a side view of the mounting clip of FIG. 13A and the release tool of FIG. 18A prior to insertion, according to various embodiments;

FIG. 18C is a side view of the mounting clip of FIG. 13A and the release tool of FIG. 18A after insertion, according to various embodiments;

FIG. 18D is a top view of the outer clip of the mounting clip of FIG. 13A and the release tool of FIG. 18A after insertion and prior to release of a locking mechanism, according to various embodiments;

FIG. 18E is a top view of the outer clip of the mounting clip of FIG. 13A and the release tool of FIG. 18A after insertion and after release of a locking mechanism, according to various embodiments;

FIG. 19A is a side view of two of the mounting clips of FIG. 13A connected to a spanning member prior to deployment on a panel, according to various embodiments;

FIG. 19B is a perspective view of a mounting clip of the two mounting clips of FIG. 19A where the mounting clip is positioned on the frame of the panel prior to clamping onto the frame, according to various embodiments;

FIG. 19C is a perspective view of the mounting clip of the two mounting clips of FIG. 19A where the mounting clip is positioned on the frame of the panel and is clamped onto the frame, according to various embodiments;

FIG. 19D is a bottom view of the panel of FIGS. 19B and 19C and the two mounting clips of FIG. 19A where the spanning member is not tightened, according to various embodiments;

FIG. 19E is a bottom view of the panel of FIG. 19D and the two mounting clips of FIG. 19A where the spanning member is tightened, according to various embodiments;

FIG. 19F is a bottom view of the panel of FIG. 19D and the two mounting clips of FIG. 19A where the spanning member is tightened and wires from junction boxes are attached to the spanning member, according to various embodiments;

FIG. 20A is a perspective view of another mounting clip for securing a spanning member to a frame of a panel, according to various embodiments;

FIG. 20B is a side view of the mounting clip of FIG. 20A, according to various embodiments;

FIG. 20C is a front view of the mounting clip of FIG. 20A, according to various embodiments;

FIG. 20D is a bottom view of the mounting clip of FIG. 20A, according to various embodiments;

FIG. 20E is a back side view of the mounting clip of FIG. 20A, according to various embodiments;

FIG. 20F is a rear view of the mounting clip of FIG. 20A, according to various embodiments;

FIG. 20G is a bottom perspective view of the mounting clip of FIG. 20A, according to various embodiments;

FIG. 21A is a partial perspective view of a portion of a mounting clip with a roller compartment with a first type of spring prior to insertion of a spanning member, according to various embodiments;

FIG. 21B is a partial top view of the portion of a mounting clip of FIG. 21A, according to various embodiments;

FIG. 21C is a partial perspective view of the portion of a mounting clip of FIG. 21A with the springs compressed after insertion of a spanning member, according to various embodiments;

FIG. 21D is a partial top view of the portion of a mounting clip of FIG. 21C with the springs compressed after insertion of a spanning member, according to various embodiments;

FIG. 21E is a partial top view of a portion of a mounting clip with a roller compartment with a second type of spring, according to various embodiments;

FIG. 21F is a partial top view of a portion of a mounting clip with roller compartment with a single roller with the first type of spring, according to various embodiments;

FIG. 21G is a partial top view of a portion of a mounting clip with roller compartment with a single roller with the second type of spring, according to various embodiments;

FIG. 21H is a partial top view of a portion of a mounting clip with roller compartment with a single roller with a fourth type of spring, according to various embodiments;

FIG. 22 is a perspective view of (a) a roller with a knurled pattern with raised areas with divots, (b) a roller with raised areas with a flat top, and (c) a roller with parallel ridges, and according to various embodiments; and

FIG. 23 is a side section view of (a) a portion of a mounting clip with a roller compartment with a roller with a center channel, (b) a portion of a mounting clip with a roller compartment with a roller with a smaller spanning member, and (c) a portion of a mounting clip with a roller compartment with a roller with a larger spanning member.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to” unless expressly specified otherwise. An enumerated listing of items does not imply that any or all of the items are mutually exclusive and/or mutually inclusive, unless expressly specified otherwise. The terms “a,” “an.” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for a zip line wire management system is disclosed. The apparatus includes a first mounting clip and a second mounting clip. The first and second mounting clips are configured to connect to a frame of a panel. The first mounting clip includes a first spanning member connection point and the second mounting clip includes a second spanning member connection point. The apparatus includes a spanning member configured to connect between the first spanning member connection point and the second spanning member connection point. The apparatus includes at least one tensioner configured to provide tension to the spanning member while the spanning member is connected between the first mounting clip and the second mounting clip. The spanning member is configured to support a wire of the panel.

In some embodiments, the spanning member includes a cable stop at a first end of the spanning member and a tensioner of the at least one tensioner at a second end of the spanning member. In other embodiments, the spanning member includes a cable stop at each end of the spanning member and a tensioner of the at least one tensioner between the first and second mounting clips. In other embodiments, the at least one tensioner includes a first tensioner on the spanning member at the first end of the spanning member and a second tensioner on the spanning member at the second end of the spanning member. In other embodiments, the cable stop positioned on a side of the first mounting clip opposite a center section between the first and second mounting clips is configured to prevent the spanning member from being pulled through the first spanning member connection point resulting from a force applied to the spanning member toward the center section.

In other embodiments, the first tensioner and/or the second tensioner each include a locking mechanism positioned on a side of the first or second spanning member connection point opposite the center section and configured to resist movement of the spanning member in a first direction toward the center section and configured to allow movement of the spanning member in a second direction opposite the first direction. Applying a force on the spanning member on an end of the spanning member with a tensioner in the second direction provides tension to the spanning member. In other embodiments, the at least one spanning member tensioner includes a spring attached to the spanning member where the spring includes a connector configured to attach to the first or second spanning member connection point.

In some embodiments, the at least one spanning member tensioner includes a spring force provided by the first mounting clip and/or the second mounting clip resulting from a force applied to the spanning member in a direction opposite a center section between the first and second mounting clips and securing the spanning member at the first and second spanning member connection points after the force is applied to the spanning member. In other embodiments, one or both of the first mounting clip and the second mounting clip include a locking mechanism configured to resist movement of the spanning member in a first direction toward a center section between the first and second mounting clips and configured to allow movement of the spanning member in a second direction opposite the first direction. Applying a force on the spanning member on an end of the spanning member in the second direction provides tension to the spanning member.

In some embodiments, the first spanning member connection point and/or the second spanning member connection point include one or more openings sized to accommodate the spanning member. In other embodiments, the apparatus includes one or more wire supports connected to the spanning member. Each wire support is configured to support the wire of the panel. In other embodiments, the spanning member includes a cable and the first mounting clip and/or the second mounting clip each include a slack management opening configured to hold a portion of the spanning member extending from the first or second mounting clip. In other embodiments, the spanning member includes at least a portion that is rigid.

Another apparatus for a zip line wire management system includes a first spanning member connection point and a second spanning member connection point. The first and second spanning member connection points are each configured to be positioned on a frame of a panel. The apparatus includes a spanning member configured to connect between the first spanning member connection point and the second spanning member connection point and at least one tensioner configured to provide tension to the spanning member while the spanning member is connected between the first spanning member connection point and the second spanning member connection point. The spanning member is configured to support a wire of the panel.

In some embodiments, the first spanning member connection point is on a first mounting clip and the second spanning member connection point is on a second mounting clip. The first mounting clip and the second mounting clip are configured to attach to the frame of the panel. In some embodiments, the spanning member includes a cable stop at a first end of the spanning member and a tensioner of the at least one tensioner at a second end of the spanning member. In other embodiments, the at least one tensioner includes a first tensioner on the spanning member at the first end of the spanning member and a second tensioner on the spanning member at the second end of the spanning member.

In other embodiments, the cable stop positioned on a side of the first mounting clip opposite a center section between the first and second mounting clips is configured to prevent the spanning member from being pulled through the first spanning member connection point resulting from a force applied to the spanning member toward the center section. In other embodiments, the first tensioner and/or the second tensioner each include a locking mechanism positioned on a side of the first or second spanning member connection point opposite the center section and configured to resist movement of the spanning member in a first direction toward the center section and configured to allow movement of the spanning member in a second direction opposite the first direction. Applying a force on the spanning member on an end of the spanning member with a tensioner in the second direction provides tension to the spanning member. In other embodiments, the at least one spanning member tensioner includes a spring attached to the spanning member where the spring includes a connector configured to attach to the first or second spanning member connection point.

In some embodiments, the at least one spanning member tensioner includes a spring force provided by the first mounting clip and/or the second mounting clip resulting from a force applied to the spanning member in a direction opposite a center section between the first and second mounting clips and securing the spanning member at the first and second spanning member connection points after the force is applied to the spanning member. In other embodiments, one or both of the first mounting clip and the second mounting clip include a locking mechanism configured to resist movement of the spanning member in a first direction toward a center section between the first and second mounting clips and configured to allow movement of the spanning member in a second direction opposite the first direction where applying a force on the spanning member on an end of the spanning member in the second direction provides tension to the spanning member.

In some embodiments, the spanning member includes a first spanning member and the tensioner includes a first tensioner and the apparatus includes a second spanning member with a second tensioner and a third spanning member connection point positioned on the frame. The second spanning member is configured to connect between the third spanning member connection point and the first spanning member. In other embodiments, the first spanning member connection point and the second spanning member connection point each include an opening in the frame of the panel.

Another apparatus for a zip line wire management system includes a first mounting clip and a second mounting clip. The first and second mounting clips are configured to connect to a frame of a panel. The first mounting clip includes a first spanning member connection point and the second mounting clip includes a second spanning member connection point. The apparatus includes a spanning member configured to connect between the first spanning member connection point and the second spanning member connection point and at least one tensioner configured to provide tension to the spanning member while the spanning member is connected between the first mounting clip and the second mounting clip. The spanning member is configured to support a wire of the panel. The spanning member includes a cable stop at a first end of the spanning member and a tensioner of the at least one tensioner at a second end of the spanning member or the at least one tensioner includes a first tensioner on the spanning member at the first end of the spanning member and a second tensioner on the spanning member at the second end of the spanning member.

In some embodiments, the cable stop positioned on a side of the first mounting clip opposite a center section between the first and second mounting clips is configured to prevent the spanning member from being pulled through the first spanning member connection point resulting from a force applied to the spanning member toward the center section. In other embodiments, the first tensioner and/or the second tensioner each include a locking mechanism positioned on a side of the first or second spanning member connection point opposite the center section and configured to resist movement of the spanning member in a first direction toward the center section and configured to allow movement of the spanning member in a second direction opposite the first direction. Applying a force on the spanning member on an end of the spanning member with a tensioner in the second direction provides tension to the spanning member.

Another apparatus with rollers for a zip line wire management system includes a mounting clip that includes an outer clip and an inner clip. The outer clip and inner clip are operable to clamp onto a frame. The apparatus includes a locking mechanism within the mounting clip configured to resist movement of a spanning member extending through the mounting clip in a first direction and to allow movement of the spanning member in a second direction opposite the first direction. The locking mechanism includes one or more rollers configured to wedge against the spanning member moving in the first direction.

In some embodiments, the outer clip and inner clip clamp onto the frame in response to the outer clip sliding into the inner clip to engage a side of the frame. In other embodiments, the side of the frame includes a horizontal portion and a vertical portion coupled to the horizontal portion. The inner clip includes a frame clip configured to engage an edge of the horizontal portion of the frame, and the outer clip includes a frame stop configured to engage the vertical portion of the frame. Sliding the outer clip towards the inner clip with the frame clip over the horizontal portion of the frame and the frame stop against the vertical portion of the frame secures the mounting clip to the frame. In other embodiments, the locking mechanism includes a roller compartment with two rollers positioned on either side of the spanning member. The roller compartment includes an angled side adjacent to each of the two rollers. The angled sides are angled to narrow in a direction towards the inner clip in the second direction. In other embodiments, an angle of each of the angled sides is in a range of 10 degrees to 35 degrees. In further embodiments, angle of each of the angled sides is in a range of 27 degrees to 33 degrees. In other embodiments, the mounting clip includes a channel that extends through the roller compartment and positioned to maintain the spanning member between the two rollers.

In some embodiments, the spanning member is a cable that includes an exterior surface with ridges and valleys and a distance between two adjacent raised areas measured in a direction perpendicular to a circumference of a roller of the one or more rollers is selected to allow a ridge of the cable to fit between the two adjacent raised areas. In other embodiments, the one or more rollers include two textured rollers with a textured outer surface in contact with the spanning member. In further embodiments, a texture pattern of the two textured rollers includes a rough surface, an irregular surface, and/or a knurled pattern. The knurled pattern includes raised areas with a rounded top, a flat top, or a top with a divot.

In some embodiments, the outer clip includes locking teeth. The locking teeth are arranged in a row in a direction that the outer clip slides through the inner clip, and the inner clip includes opposing teeth positioned to mate with the locking teeth and to oppose sliding the outer clip away from the inner clip. In other embodiments, the opposing teeth are mounted on a clip release lever configured to disconnect the opposing teeth from the locking teeth upon application of a force on the clip release lever. In other embodiments, the outer clip includes a frame stop configured to engage a vertical portion of the frame and the frame stop includes a tensioner arm oriented towards the inner clip. The tensioner arm is configured to provide a spring force opposing movement of the frame stop towards the frame. A range of the tensioner arm is greater than a distance between two adjacent locking teeth of the locking teeth of the outer clip.

In some embodiments, the inner clip includes a retainer channel and the outer clip includes a retainer tooth positioned in the retainer channel or the outer clip includes a retainer channel and the inner clip includes a retainer tooth positioned in the retainer channel. One or both ends of the retainer channel are positioned to limit travel of the outer clip within the inner clip to maintain the one or more rollers within a roller compartment. In other embodiments, the spanning member includes a cable and the cable includes a stainless-steel cable or a galvanized steel cable, and/or the cable includes a coating and the coating includes a plastic, a polymer, and/or a rubber. In other embodiments, the apparatus includes a slack management opening integral to the mounting clip and configured to hold a portion of the spanning member extending from the mounting clip. In further embodiments, the slack management opening includes a gap between the outer clip and the inner clip running in a direction that the outer clip slides with respect to the inner clip.

In some embodiments, the locking mechanism includes a roller compartment with the one or more rollers. The roller compartment includes a spring for each of the one or more rollers configured to exert a spring force on the roller. The spring is arranged to exert the spring force in the first direction.

A system for wire management of a frame includes a first mounting clip, a second mounting clip, and a spanning member positioned between the first mounting clip and the second mounting clip. Each mounting clip includes an outer clip, an inner clip, and a locking mechanism. The outer clip and inner clip of the first mounting clip are operable to clamp onto a first side of a frame and the outer clip and inner clip of the second mounting clip are operable to clamp onto a second side of the frame. The locking mechanism within each mounting clip is configured to resist movement of the spanning member extending through the mounting clip in a first direction towards the inner clip of the mounting clip and to allow movement of the spanning member in a second direction opposite the first direction. The locking mechanism includes one or more textured rollers configured to wedge against the spanning member moving in the first direction. The first mounting clip and the second mounting clip are positionable on the frame to tighten the spanning member between the first mounting clip and second mounting clip.

In some embodiments, the frame is a frame of an electrical panel and the spanning member is a cable configured to support wiring of the electrical panel.

Another apparatus for wire management of a frame includes a mounting clip with an outer clip and an inner clip. The outer clip and inner clip are operable to clamp onto a frame. The frame includes a horizontal portion and a vertical portion coupled to the horizontal portion. The inner clip includes a frame clip configured to engage an edge of the horizontal portion of the frame and the outer clip includes a frame stop configured to engage the vertical portion of the frame. Sliding the outer clip towards the inner clip with the frame clip over the horizontal portion of the frame and the frame stop against the vertical portion of the frame secures the mounting clip to the frame. Each outer clip includes locking teeth and the locking teeth are arranged in a row in a direction that the outer clip slides through the inner clip. Each inner clip includes opposing teeth positioned to mate with the locking teeth and to oppose sliding the outer clip away from the inner clip. The apparatus includes a cable and a locking mechanism within each mounting clip configured to resist movement of the cable extending through the mounting clip in a first direction and to allow movement of the cable in a second direction opposite the first direction. The locking mechanism includes a roller compartment with two textured rollers positioned on either side of the cable configured to wedge against the cable moving in the first direction. The roller compartment includes an angled side adjacent to each of the two textured rollers. The angled sides are angled to narrow in a direction towards the inner clip in the second direction. An angle of each of the angled sides is in a range of 10 degrees to 35 degrees.

In some embodiments, the cable includes an exterior surface with ridges and valleys and a distance between two adjacent raised areas measured in a direction perpendicular to a circumference of the textured roller is selected to allow a ridge of the cable to fit between the two adjacent raised areas.

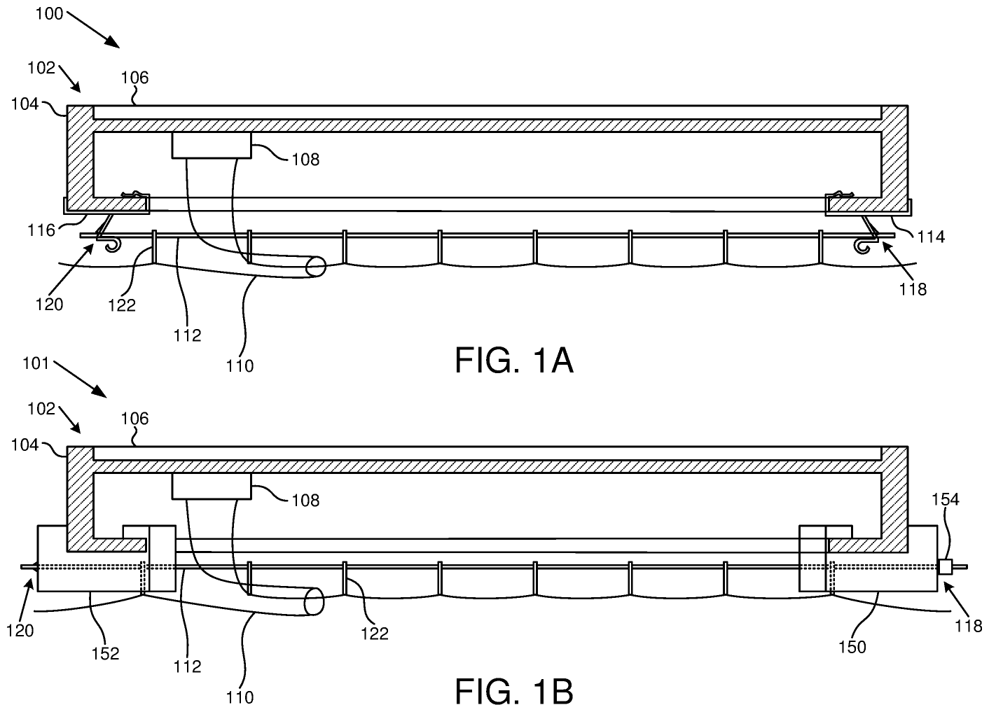

FIG. 1A is a side section view illustrating a panel 102 with a zip line wire management system 100 with a first type of mounting clips 114, 116, according to various embodiments. A panel 102, in some embodiments is a solar panel that includes a frame 104 and solar cells 106 connected to a junction box 108. In other embodiments, the panel 102 is another type of panel with electrical components. A junction box, as used herein, is any box, compartment, void, etc. where wire 110 enters and connects to other wires or to an electrical component. In various examples, a junction box includes a box at the back of a solar panel, a cavity at the back of a light fixture, a stand-alone electrical junction box, an entry point at an electrical component, and the like. Often a solar panel 102 includes a frame 104 with a top surface that supports one or more solar cells 106 that generate electrical energy when exposed to the sun. The solar cells 106 include one or more wires that terminate in a junction box 108 and wires 110 extending from the junction box 108. A typical solar panel installation includes an array of solar panels, each with a junction box 108 and wires 110 that often daisy chain together, are connected in parallel, are connected in series, or some combination thereof. Wire management is a constant issue and often solar panel installations end up with wires 110 drooping down onto a roof, which often has an abrasive surface. Weather conditions and wind often damage the wires 110.

A zip line wire management system 100 as described herein provides a spanning a spanning member 112 configured to support the wires 110, which helps prevent damage to the wires 110 and provides a way to create a more visually pleasing installation. In some embodiments, the spanning member 112 is connected between a first mounting clip 114 and a second mounting clip 116, which are mounted to the frame 104. The first mounting clip 114 includes a first spanning member connection point 118 and the second mounting clip 116 includes a second spanning member connection point 120 where the spanning member 112 is configured to connect between the first spanning member connection point 118 and the second spanning member connection point 120.

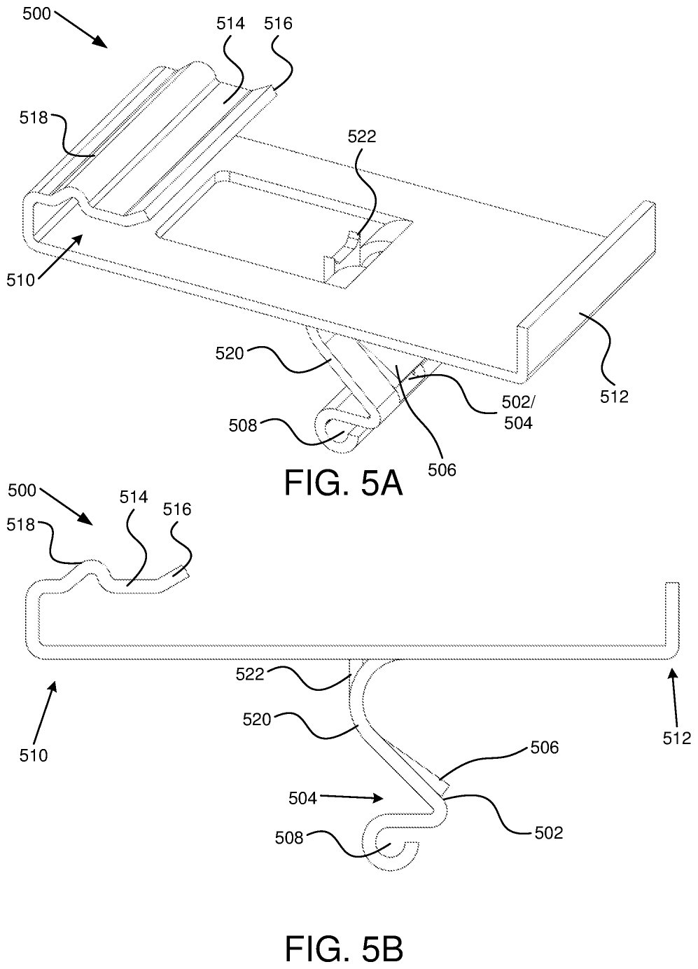

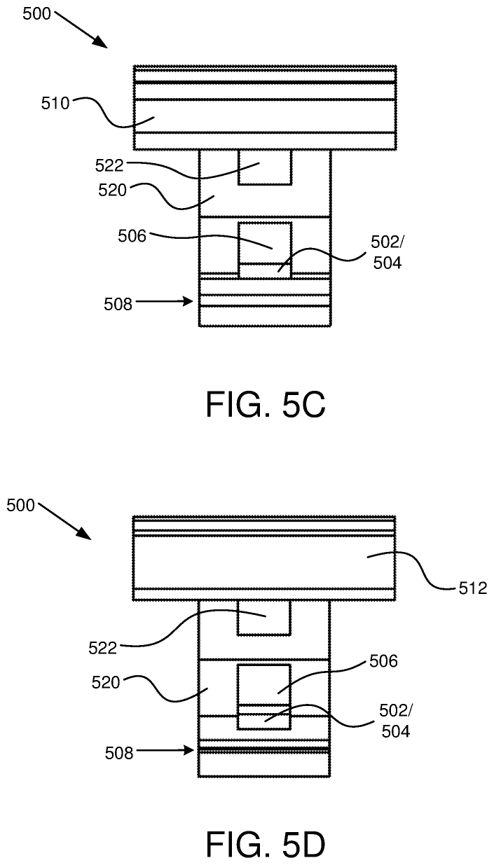

The zip line wire management system 100 includes a tensioner configured to provide tension to the spanning member 112 while the spanning member 112 is connected between the first mounting clip 114 and the second mounting clip 116. In some embodiments, at least one tensioner is configured to provide tension to the spanning member 112 while the spanning member 112 is connected between the first mounting clip 114 and the second mounting clip 116. In the embodiment depicted in FIG. 1A, the first and second mounting clips 114, 116 each include a tensioner (first tensioner and second tensioner), as depicted in more detail in the embodiments of FIGS. 5A-5D. In some embodiments, the tensioner in FIG. 1A includes a spring force provided by the arm extending upward to the connection points 118, 120.

The first tensioner and the second tensioner each include a locking mechanism positioned on a side of the first or second spanning member connection point 118, 120 opposite the center section between the first and second mounting clips 114, 116 and configured to resist movement of the spanning member 112 in a first direction toward the center section and configured to allow movement of the spanning member 112 in a second direction opposite the first direction. Applying a force on the spanning member 112 on an end of the spanning member with a tensioner in the second direction provides tension to the spanning member 112.

The tensioners of FIG. 1A are in the form of an angled tab configured to resist movement of the spanning member 112 in a first direction toward the center section and configured to allow movement of the spanning member 112 in a second direction opposite the first direction. In some embodiments, the tab has a sharp edge, groove, indentation, etc. and is angled in such a way that movement of the spanning member 112 in one direction causes the tab to dig into the spanning member 112 preventing further movement. Movement of the spanning member 112 in an opposite direction moves the tab in a way that the spanning member 112 is able to continue to move.

Applying tension to the spanning member 112 helps to maintain the spanning member 112 substantially straight between the first and second spanning member connection points 118, 120. Maintaining the spanning member 112 substantially straight includes providing enough tension to avoid any substantial drooping such that the spanning member 112 is suitable for supporting the wire 110 to prevent the wire 110 from drooping.

In some embodiments, the tensioners described herein provide an amount of tension to allow for thermal expansion, prevent damage to mounting clips, and to the spanning members while providing enough support for wires to prevent damage due to wind, rubbing on roof shingles, structural elements, etc. In some embodiments, the spanning member(s) and tensioner(s) are made of materials that avoid stretching and sagging over time, such as high quality metals, springs, etc. In some embodiments, the tensioners described herein provide a low amount of tension to prevent failure caused by thermal cycling of high tension spanning members while providing enough tension to avoid sagging that would lead to damage of the wires 110.

In some embodiments, the spanning member 112 is rigid, such as a solid wire, stamped steel, or the like. Where the spanning member 112 is rigid, tensioning requirements may be less and may include merely supporting the spanning member 112 in a fixed position. In other embodiments, the spanning member 112 is flexible, such as a stainless-steel cable, a plastic-coated stainless-steel cable, a zinc-coated cable, and aluminum cable, a polymer cable, or the like. Where the spanning member 112 is flexible, the tensioner provides tension on the spanning member 112 to prevent sagging and is configured to retain the spanning member 112 with tension for an extended period of time. Various tensioners to be used with the zip line wire management system 100 are described below.

In the embodiments of FIG. 1A, the spanning member 112 includes wire supports 122 that support the wires 110. In some embodiments, the wire supports 122 are fixed to the spanning member 112. In other embodiments, the wire supports 122 are movable along the spanning member 112. In other embodiments, the wire supports 122 are configured to be loaded onto the spanning member 112 before the spanning member 112 is placed in the mounting clips 114, 116. In other embodiments, the wire supports 122 may be placed on the spanning member 112 after the spanning member 112 is placed in the mounting clips 114, 116.

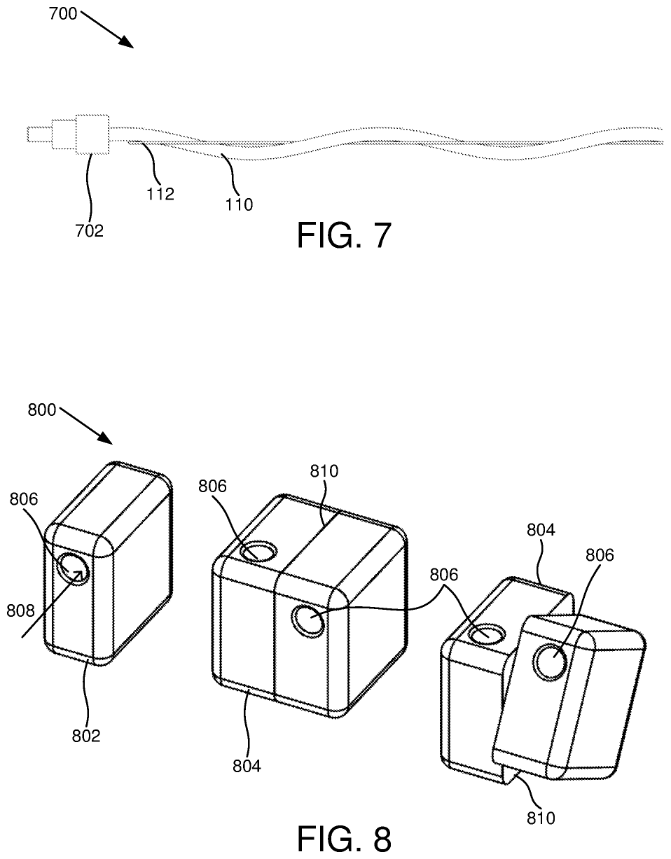

In some embodiments, the wire supports 122 are clips that clip to the spanning member 112 at one end and include a hanger, a C-shaped loop, or other structure suitable for supporting the wire 110 at the other end of the wire supports 122. In some embodiments, the wire supports 122 are metal, such as stainless steel or plastic-coated metal. In other embodiments, the wire supports 122 are nylon, plastic or the like. In some embodiments, the wire supports 122 are designed to not degrade or to degrade an acceptable amount during an expected lifetime while exposed to sun, wind, heat, cold, moisture, etc. One of skill in the art will recognize other forms of a wire supports 122 configured to support the wire 110. In other embodiments, the spanning member 112 does not include wire supports 122 and the wire 110 is wrapped around the spanning member 112, as depicted in FIG. 7.

In the embodiments of FIG. 1A, the junction box 108 includes two wires 110, which is typical for solar panels. One wire 110 on the right side may connect to a solar panel on the right and the other wire 110 extending to the left may connect to another solar panel on the left side. In some embodiments, the wire 110 is looped to take up slack. One of skill in the art will recognize other ways to use the spanning member 112 to support wires 110.

The wires 110 are typically not designed to have high tension. Where wires 110 are wound around spanning members 112, as depicted in FIG. 7, the wires 110 typically are supported without stretching the wires 110 enough to cause damage. Likewise, where wire supports 122 are provided, the spanning members 112 may include tension while the wires 110 may be strung with lower tension by having enough tension minimize drooping while not having too much tension to cause damage.

FIG. 1B is a side section view illustrating a panel 102 with a zip line wire management system 101 with a second type of mounting clips 150, 152, according to various embodiments. The zip line wire management system 101 of FIG. 1B includes a panel 102 that is a solar panel that includes a frame 104 and solar cells 106 connected to a junction box 108, as in FIG. 1A. In other embodiments, the panel 102 is another type of panel with electrical components. The solar cells 106 include one or more wires that terminate in a junction box 108 and wires 110 extending from the junction box 108.

The zip line wire management system 101 of FIG. 1B includes a spanning a spanning member 112 configured to support the wires 110. In some embodiments, the spanning member 112 is connected between a first mounting clip 150 and a second mounting clip 152, which are mounted to the frame 104. The first mounting clip 150 includes a first spanning member connection point 118 and the second mounting clip 152 includes a second spanning member connection point 120 where the spanning member 112 is configured to connect between the first spanning member connection point 118 and the second spanning member connection point 120.

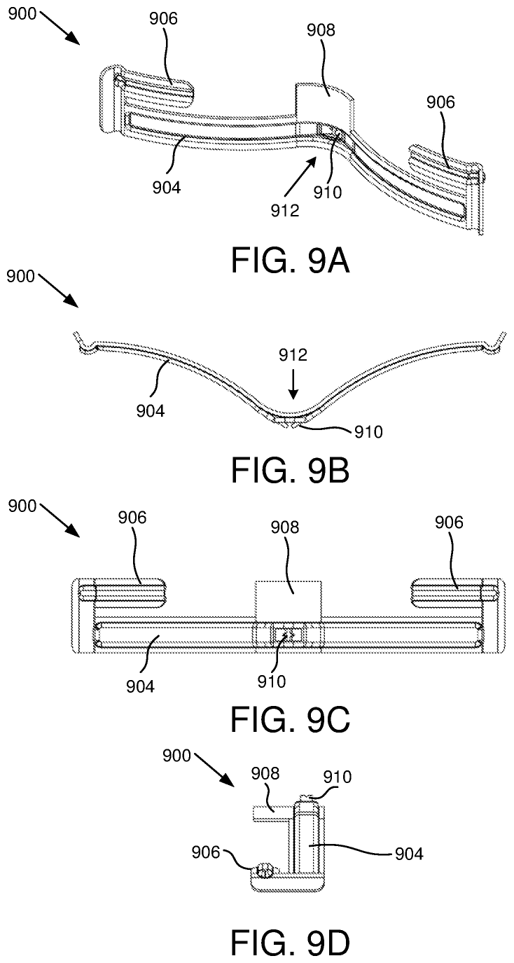

The zip line wire management system 101 of FIG. 1B includes a tensioner configured to provide tension to the spanning member 112 while the spanning member 112 is connected between the first mounting clip 150 and the second mounting clip 152. In the embodiments of FIG. 1B, one tensioner on the second mounting clip 152 is configured to provide tension to the spanning member 112 while the spanning member 112 is connected between the first mounting clip 150 and the second mounting clip 152. In the embodiment depicted in FIG. 1B, the first mounting clip 150 does not include a tensioner but instead the spanning member 112 includes a cable stop 154 that prevents the spanning member 112 from pulling through the first spanning member connection point 118 toward the second mounting clip 152. The second mounting clip 152 is depicted in more detail in the embodiments of FIGS. 9A-9D.

The first mounting clip 150 is similar to the second mounting clip 152 but may or may not include a tensioner. Where the first mounting clip 150 includes a tensioner, the cable stop 154 may not be included. The tensioners are in the form of one or more angled tabs configured to resist movement of the spanning member 112 in a first direction toward a center section between the first and second mounting clips 150, 152 and configured to allow movement of the spanning member 112 in a second direction opposite the first direction. Applying a force on the spanning member 112 on an end of the spanning member 112 in the second direction provides tension to the spanning member 112. In the embodiments of FIG. 1B, the spanning member 112 includes wire supports 122 that support the wires 110 similar to the wire supports 122 of FIG. 1A.

In the embodiments of FIG. 1B, as with FIG. 1A the junction box 108 includes two wires 110, which is typical for solar panels. One wire 110 on the right side may connect to a solar panel on the right and the other wire 110 extending to the left may connect to another solar panel on the left side.

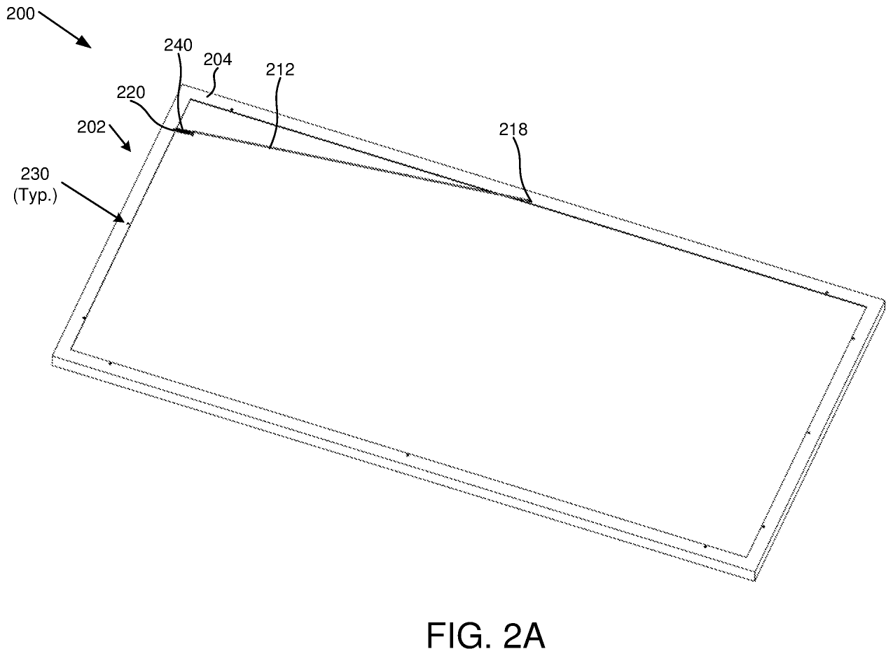

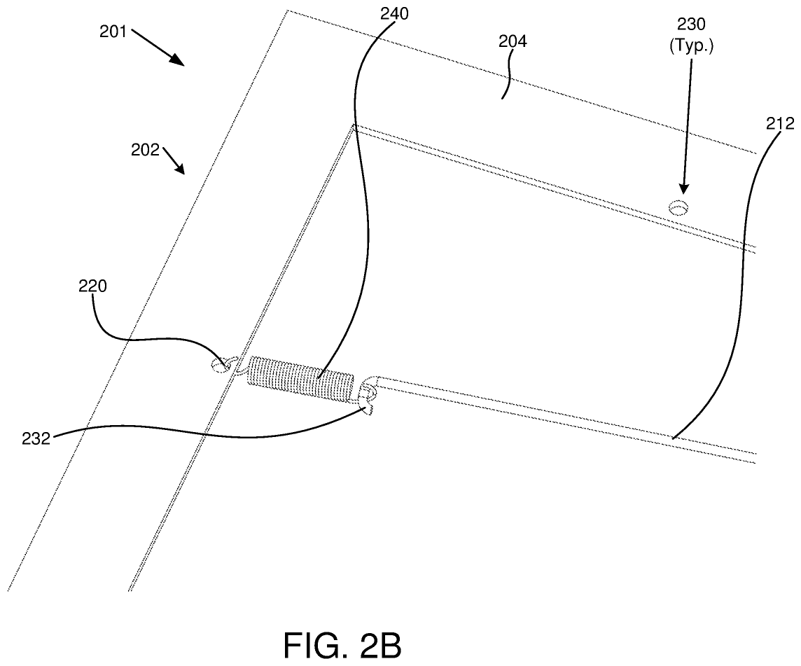

FIG. 2A is a perspective view 200 illustrating a panel 202 with a spanning member 212 connected between openings 230 of a frame 204 of the panel 202, according to various embodiments. FIG. 2B is a close-up view 201 of an end of the spanning member of FIG. 2A illustrating a tensioner in the form of a spring 240, according to various embodiments. In some embodiments, the panel 202 is a solar panel. In some embodiments, the panel 202 of FIGS. 2A and 2B is similar to the panel 102 of FIGS. 1A and 1B, but include openings 230, which may be used for connection of spanning members 212. (As used herein, panel 102 and panel 202 are used interchangeably.) The spanning member 212 is similar to the spanning member 112 of FIGS. 1A and 1B.

The panel 202, in the embodiments, depicted in FIGS. 2A and 2B includes a first spanning connection point 218 and a second spanning connection point 220 in the form of openings 230 in the frame 204. In the embodiments depicted in FIGS. 2A and 2B the spanning member 212 is rigid and includes a bent end 232 to connect to the openings 230. In other embodiments, the spanning member 212 is flexible and may be connected via a cable stop, cable clamp, or the like.

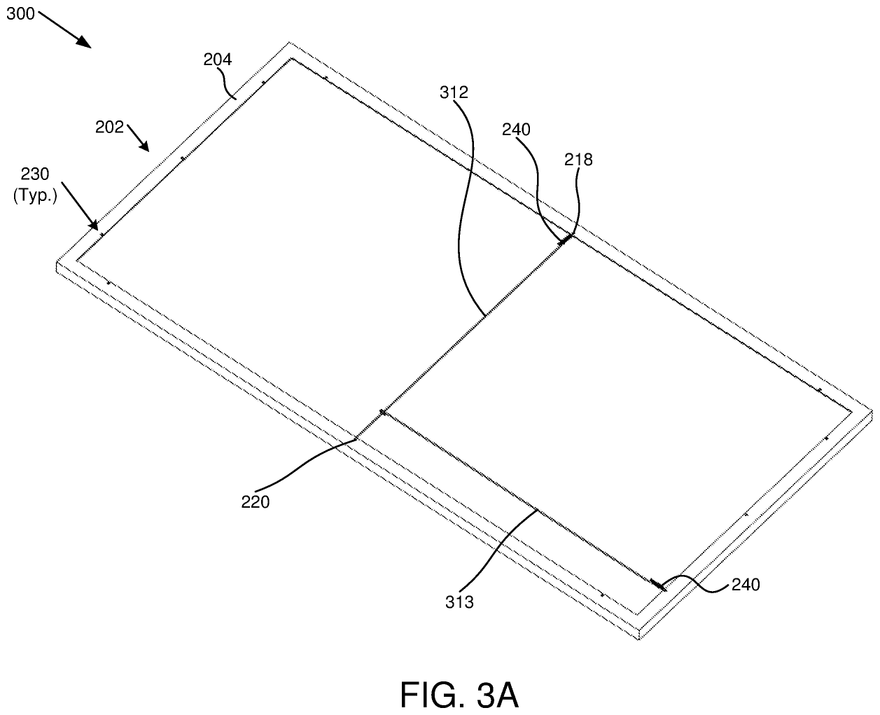

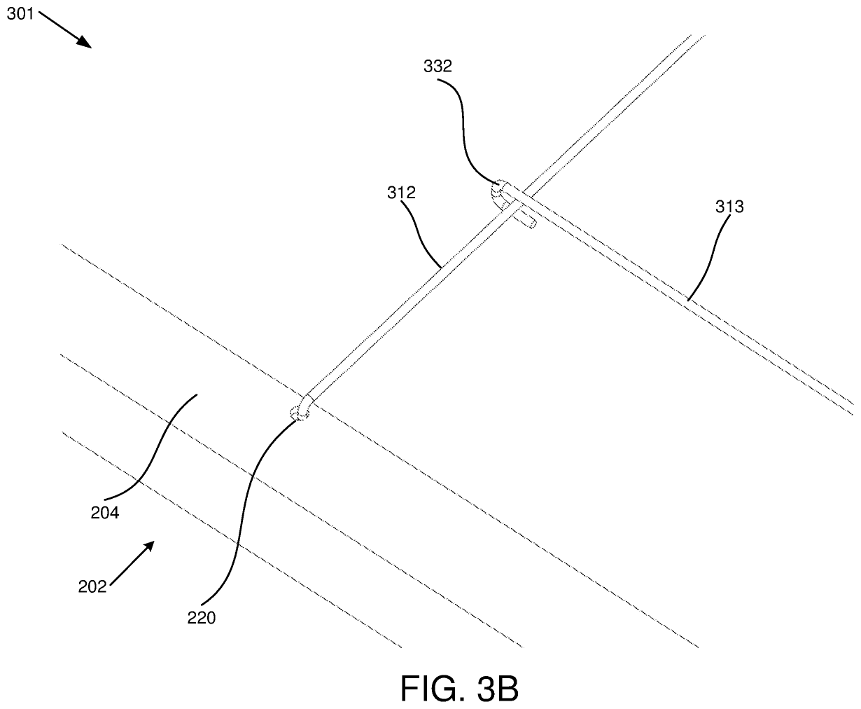

FIG. 3A is a perspective view 300 illustrating a panel 202 with a first spanning member 312 connected between openings 230 of a frame 204 of the panel 202 and a second spanning member 313 connected between an opening 230 in the frame 204 and the first spanning member 312, according to various embodiments. FIG. 3B is a close-up view 301 of a connection between the first spanning member 312 and the second spanning member 313 of FIG. 3A, according to various embodiments. The first and second spanning members 312, 313 each include a tensioner in the form of a spring 240, which is similar to the spring 240 of FIGS. 2A and 2B. The panel 202 of FIGS. 3A and 3B is substantially similar to the panel 202 of FIGS. 2A and 2B.

In some embodiments, the spanning member 312 does not include a spring 240 but is instead sized to connect to each of the first spanning connection point 218 and the second spanning connection point 220. In the embodiment, the frame 204 may include some amount of flex so that the spanning member 312 may be inserted into holes serving as the first spanning connection point 218 and the second spanning connection point 220 and the flex provides some spring force to hold the spanning member 312 in place. Where the spanning member 312 is cut to length and fits in hole serving as the first spanning connection point 218 and the second spanning connection point 220, in some embodiments, the spanning member 312 is rigid.

The panel 202, in the embodiments, depicted in FIGS. 3A and 3B includes a first spanning connection point 218 and a second spanning connection point 220 for the first spanning member 312 in the form of openings 230 in the frame 204. In the embodiments depicted in FIGS. 3A and 3B the first spanning member 312 and the second spanning member 313 are rigid and includes a bent end 332 to connect to the openings 230 and to the first spanning member 312. In other embodiments, the spanning members 312, 313 are flexible and may be connected via a cable stop (e.g., 154), cable clamp, or the like. In some embodiments, the spanning members 312, 313 may include a tensioner different than the spring 240, such as a tensioner located in a middle section of a spanning member 312, 313.

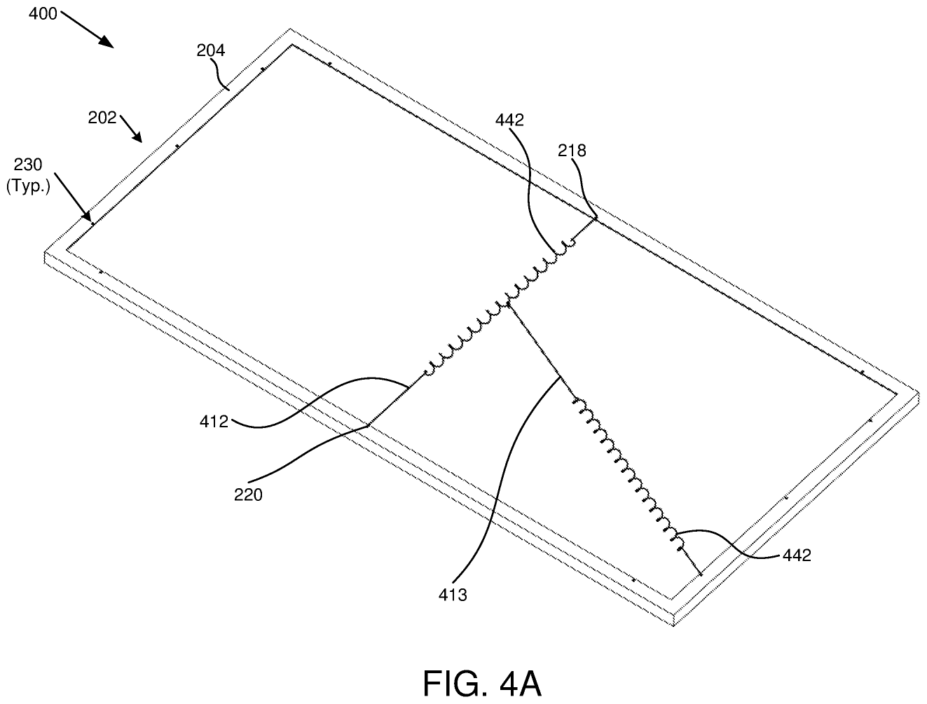

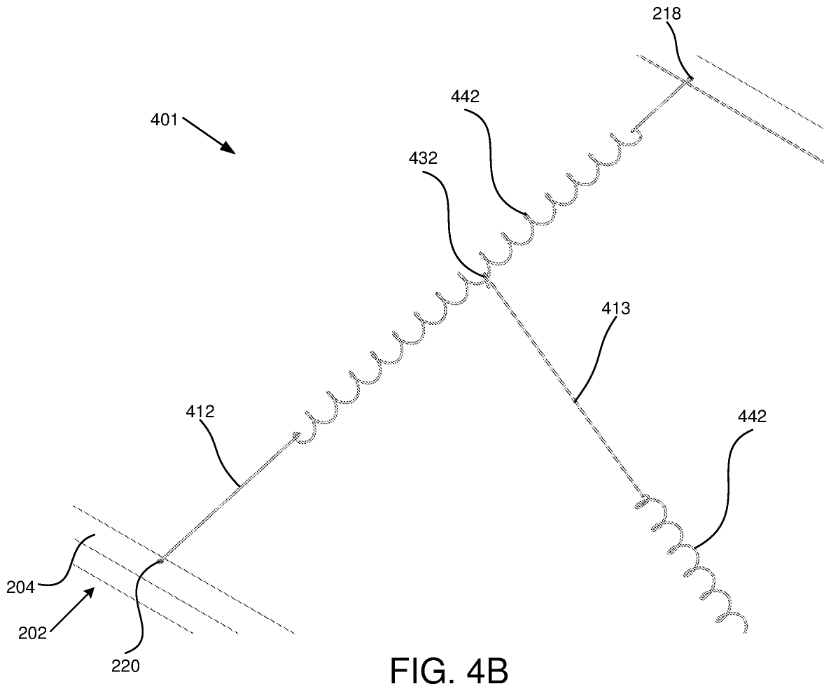

FIG. 4A is a perspective view 400 illustrating a panel 202 with a first spanning member 412 with a spring section 442 connected between openings 230 of a frame 204 of the panel 202 and a second spanning member 413 with a spring section 442 connected between an opening 230 in the frame 204 and the first spanning member 412, according to various embodiments. FIG. 4B is a close-up view 401 of a connection between the first spanning member 412 and the second spanning member 413 of FIG. 4A, according to various embodiments. The first and second spanning members 412, 413 each include a tensioner in the form of a spring section 442. The panel 202 of FIGS. 4A and 4B is substantially similar to the panel 202 of FIGS. 2A and 2B.

The panel 202, in the embodiments, depicted in FIGS. 4A and 4B includes a first spanning connection point 218 and a second spanning connection point 220 for the first spanning member 412 in the form of openings 230 in the frame 204. In the embodiments depicted in FIGS. 4A and 4B the first spanning member 412 and the second spanning member 413 are rigid and includes a bent end 432 to connect to the openings 230 and to the first spanning member 312. In other embodiments, the spanning members 412, 413 are flexible and may be connected via a cable stop (e.g., 154), cable clamp, or the like. In some embodiments, the spanning members 412, 413 may include a tensioner different than the spring section 442, such as a tensioner located in a middle section of a spanning member 412, 413.

In some embodiments, instead of tensioner in the form of a spring 442, a section of the spanning member 412 is in the form of a wire weave that provides some flexibility and spring force. The wire weave allows some stretching of the spanning member 412 sufficient to allow an end of the spanning member 412 to stretch enough to fit into a spanning connection point 218, 220 while retaining enough rigidity to hold the spanning member 412 taught to support a wire 110. A section of the spanning member 412 in the form of a spring or a wire weave are two of many possible designs to provide a spanning member 412 with a spring force serving as a tensioner.

FIG. 5A is a perspective view illustrating a mounting clip 500 with a spanning member connection point 502 and slack management slot 508, according to various embodiments. FIG. 5B is a side view of the mounting clip 500 of FIG. 5A, FIG. 5C is a first end view of the mounting clip 500 of FIG. 5A, and FIG. 5D is a second end view of the mounting clip 500 of FIG. 5A. The spanning member connection point 502 includes and opening 504 for a spanning member (e.g., 112, 212, 312, 313, 412, 413). A tab 506 angled toward the opening 504 provides a tensioner to resist movement of the spanning member in a direction toward the tab 506 (right to left in FIG. 5B) and to allow movement in the opposite direction (left to right in FIG. 5B).

The slack management slot 508 is configured so that for a flexible spanning member, an end extending past the tab 506 is able to be wrapped back around and inserted into the slack management slot 508. The slack management slot 508 is sized to accommodate the diameter and/or shape of the spanning member and provides a convenient way to hold an excess length of the spanning member extending past the tab 506 of the tensioner of the mounting clip 500.

The mounting clip 500 is shaped to fit around an edge of a frame of a panel, such as the frame 104 of the panel 102 of FIGS. 1A and 1B or the panels 202 of FIGS. 2A, 2B, 3A, 3B, 4A, 4B. The mounting clip 500 includes a U-shaped section 510 configured to fit around a first edge of the frame and an L-shaped section 512 to fit around a second edge of the frame opposite the first edge, as depicted in FIG. 1A. A side 514 of the U-shaped section 510, in some embodiments, includes a beveled edge 516 shaped to facilitate sliding the U-shaped section 510 around an edge of the frame. A curved section 518 of the side 514 of the U-shaped section 510 may be included to provide a spring force to allow the mounting clip 500 to bend when sliding the L-shaped section 512 around an edge of the frame.

An extension section 520 is configured to place the spanning member connection point 502 a distance away from the frame. The length of the extension section 520 is sized to provide a chosen distance from the spanning member connection point 502 to the frame. In some embodiments, an anchor tab 522 extends from the extension section 520 and is sized to contact the frame to further hold the mounting clip 500 against the frame. In some embodiments, an end of the anchor tab 522 is spiked to dig into the frame. The mounting clip 500 is sized for a particular frame and different sizes may be provided for different frames.

In some embodiments, the extension section 520 is shaped to provide a spring force and act as a tensioner. As a spanning member (e.g., 112, 212, 312, 412, 413) is inserted into the opening, force may be applied to the spanning member 112, 212, 312, 412, 413 and to the extension section 520 so that the extension section 520 flexes, which then provides a spring force on the spanning member 112, 212, 312, 412, 413. Where two mounting clips 500 are used, both provide a spring force through the extension section 520. Each extension section 520, in some embodiments, also includes a tab 506 provides one-way locking of the spanning member 112, 212, 312, 412, 413. In some embodiments, one of the mounting clips 500 does not have a locking tab 506 and the spanning member 112, 212, 312, 412, 413 includes a cable stop 154 and a mounting clip 500 at an opposite end of the spanning member 112, 212, 312, 412, 413 has a locking tab 506.

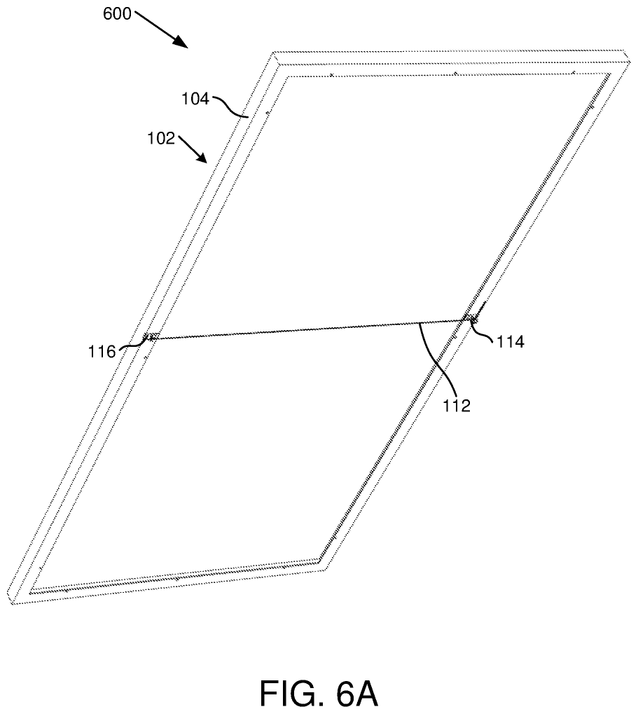

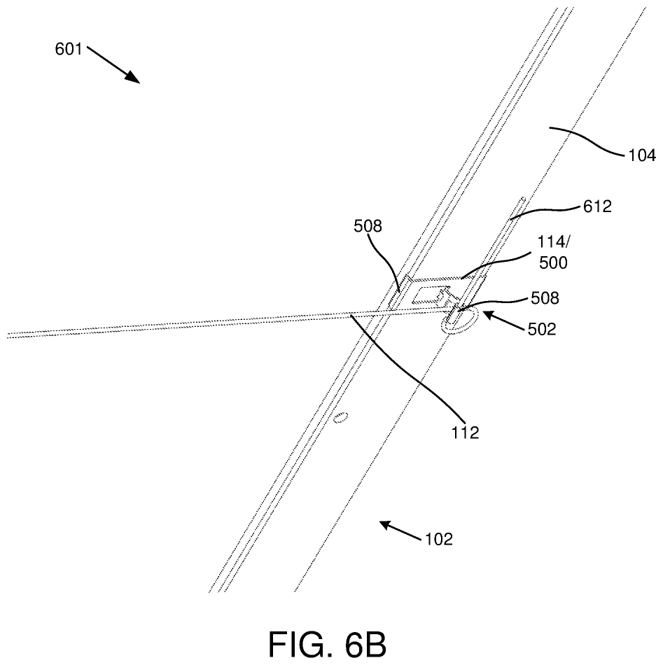

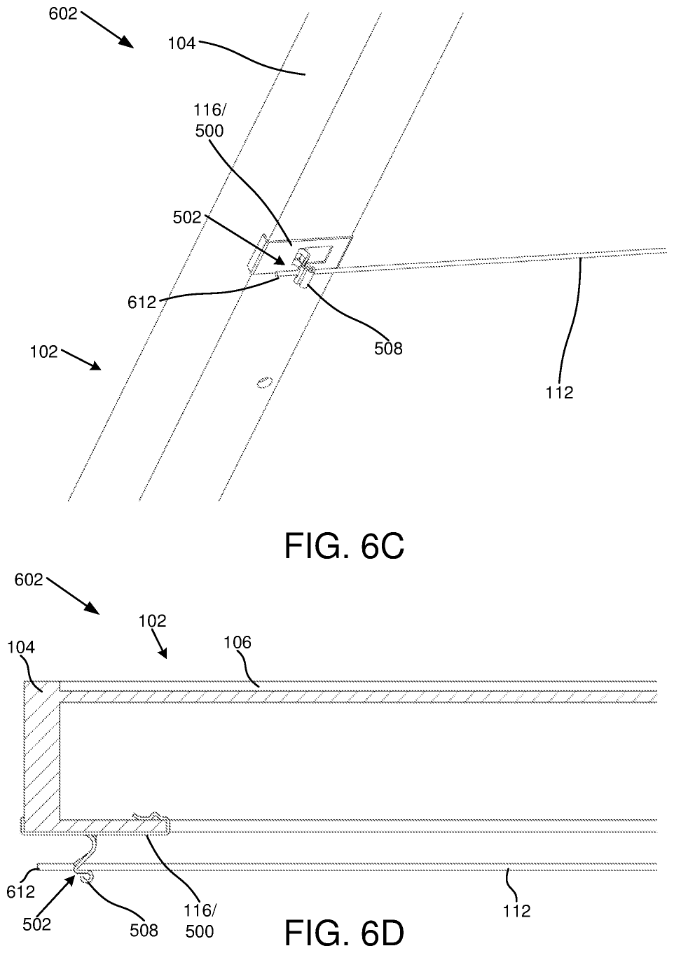

FIG. 6A is a perspective view 600 illustrating a panel 102 (or panel 202) with a spanning member 112 connected between a mounting clips 114, 116 similar to the mounting clip of FIGS. 5A-5D that are connected to a frame 104 of the panel 102, according to various embodiments. FIG. 6B is a close-up view 601 of a first mounting clip 114 of FIG. 6A connected to the frame 104, according to various embodiments. FIG. 6C is a close-up view 602 of a second mounting clip 116 of FIG. 6A connected to the frame 104, according to various embodiments. FIG. 6D is a close-up side section view 603 of the second mounting clip 116 of FIG. 6A connected to the frame 104, according to various embodiments.

The panel 102 is similar to the panels of FIGS. 1A, 1B, 2A, 2B, 3A, 3B, 4A, and 4B. In some embodiments, the panel 102 is a solar panel, as described in FIGS. 1A and 1B. The panel 102 includes a frame 104 with a spanning member 112 connected between a first mounting clip 114 and a second mounting clip 116, which are attached to the frame 104. FIG. 6B depicts the first mounting clip 114, which is substantially similar to the mounting clip 500 of FIGS. 5A-5D. In FIG. 6B, the spanning member 112 is flexible, such as a flexible cable and is routed through the spanning member connection point 502 and an end 612 exiting the spanning member connection point 502 loops back around and is inserted in the slack management slot 508.

FIGS. 6B and 6C depict the second mounting clip 116 attached to the frame 104 where the first mounting clip 114 is also the substantially similar to the mounting clip 500 of FIGS. 5A-5D. In FIG. 6C, an end 612 of the spanning member 112 extends from the first mounting clip 114, but is short and is not long enough to connect to the slack management slot 508. While a flexible spanning member 112 is depicted in FIGS. 6A-6D, in other embodiments a spring 240, 442, as depicted in FIGS. 3B, 4A could be added to either a rigid spanning member or to a flexible spanning member and could be used with the mounting clips 500 of FIGS. 5A-5D, 6A-6D or the mounting clips 900 of FIGS. 9A-9D.

FIG. 7 is a side view of an illustration 700 of a spanning member 112 with a wire 110 wrapped around the spanning member 112, according to various embodiments. Where a wire support 122 is not provided, the wire 110 may be wrapped around a spanning member 112. The wire 110 is depicted with some type of termination 702, which may be plugged into a junction box 108 or other connector.

FIG. 8 is a perspective view 800 of a single tensioner 802 and two views of a double-hole tensioner 804, according to various embodiments. The single tensioner 802 is configured for a spanning member 112 to be inserted into an opening 806 and exit another opening (not shown). The single tensioner 802 includes locking mechanism configured to resist movement of the spanning member 112 in a first direction 808 and configured to allow movement of the spanning member 112 in a second direction opposite the first direction. In some embodiments, the opening 806 is a lock path entrance that is part of a lock path extending through the single tensioner 802 to a lock path exit. In some embodiments, the single tensioner 802 includes a slack management opening (not shown) integral to a housing of the single tensioner 802 that is configured to hold a portion of the spanning member 112 extending from the lock path exit. In some embodiments, the single tensioner 802 may be used in an application where the mounting clips 114, 116 are not locking, such as for holes 230 in the panel 202.

In various embodiments, the first tensioner is substantially similar to the locking apparatus described in U.S. Provisional patent application Ser. No. 17/990,683 for Brady Schimpf et al., titled “LOCKING APPARATUS FOR WIRE MANAGEMENT WITH SLACK CABLE MANAGEMENT.” filed Nov. 19, 2022 [hereinafter “the '683 application”] and the locking apparatus described in U.S. Provisional patent application Ser. No. 18/087,634 for Brady Schimpf et al., titled “LOCKING APPARATUS FOR WIRE MANAGEMENT.” filed Dec. 22, 2022 [hereinafter “the '634 application”], which are incorporated herein by reference for all purposes.

The double tensioner 804 is similar to the single tensioner 802 but is joined with a second tensioner connected with a pivot device (not shown) that allows the two tensioners 804 to rotate along a plane 810, as depicted in the double tensioner 804 to the right, which allows two spanning members 112 to be inserted at right angles or in a same direction. For example, the double tensioner 804 may be used in an application where the first and second mounting clips 114, 116 are not locking and spanning members 112 at the mounting clips 114, 116 include cable stops 154 and the double tensioner 804 is located between the mounting clips 114, 116. In some embodiments, the double tensioner 804 has a pivot device but locks into a particular position.

In some embodiments, one or both of the tensioners 802, 804 each include a metal body with a covering. In some embodiments, the metal includes stainless-steel, steel, zinc-coated steel, and/or aluminum. In other embodiments, the covering is plastic, a polymer, rubber, an electrical insulation material, a ultraviolet (“UV”) light-resistant material, a weather-resistant material, or the like. In some embodiments, the covering includes an opening exposing a marking on the metal body, such as a model number, a serial number, etc.

In some embodiments, the locking mechanism of the tensioners 802, 804 includes three balls positioned to surround the spanning member 112 extending through the locking mechanism. In other embodiments, the locking member includes a plate where the plate includes a retaining structure for each of three balls shaped to maintain a ball of the three balls in a position against the spanning member 112. In other embodiments, the locking mechanism includes a spring positioned to push on the plate to maintain pressure on the three balls. In some embodiments, one or both of the tensioners 802, 804 include an injection molded body. Details of the locking mechanism, the housing, the body, the slack management opening, etc. are described in more detail in the '683 application and/or the '634 application.

FIG. 9A is a perspective view of another mounting clip 900 configured to mount to a frame 104 of a panel 102, according to various embodiments. FIG. 9B is a top view of the mounting clip 900 of FIG. 9A, according to various embodiments. FIG. 9C is a side view of the mounting clip 900 of FIG. 9A, according to various embodiments. FIG. 9D is an end view of the mounting clip 900 of FIG. 9A, according to various embodiments. The mounting clip 900 is configured to mount to an edge of the frame 104, as depicted in FIG. 1B. In other embodiments, the mounting clip 900 is configured to mount to any flanged structural component. In some examples, the mounting clip 900 is configured to mount to an I-beam, an angle iron, or the like. The mounting clip 900 includes a spring section 904 with front clips 906 and a back clip 908. The mounting clip 900 includes a tensioner 910 which is a spanning member connection point 118, 120.

The tensioner 910 is in the form of a hole with tabs bent in a direction away from the spring section 904. A spanning member 112 inserted in the tensioner 910 from a direction 912 away from a direction of that the tabs are bent so that the spanning member 112 is prevented from moving in an opposite direction. Front clips 906 are configured to wrap around an inside edge of the frame 104, as depicted in FIG. 1B, and a back clip 908 is configured to extend up a front edge of the frame 104.

In some embodiments, the mounting clip 900 is made of a metal or other material configured with a spring force so that when installed on a frame 104, the mounting clip 900 is configured to flex toward the frame 104 when a force on the spanning member 112 is directed toward a center between mounting clips 114, 116 on a panel 102.

In some embodiments, the mounting clips 900 do not include a tensioner 910 but include a hole for the spanning member 112. In the embodiments, a stopping mechanism such as a cable stop 154, button, flared out section, or similar device larger than the opening prevents the spanning member 112 from going past the stopping mechanism. In the embodiments, a separate tensioner, such as the tensioners 802, 804 of FIG. 8 provide tension to the spanning member(s) 112.

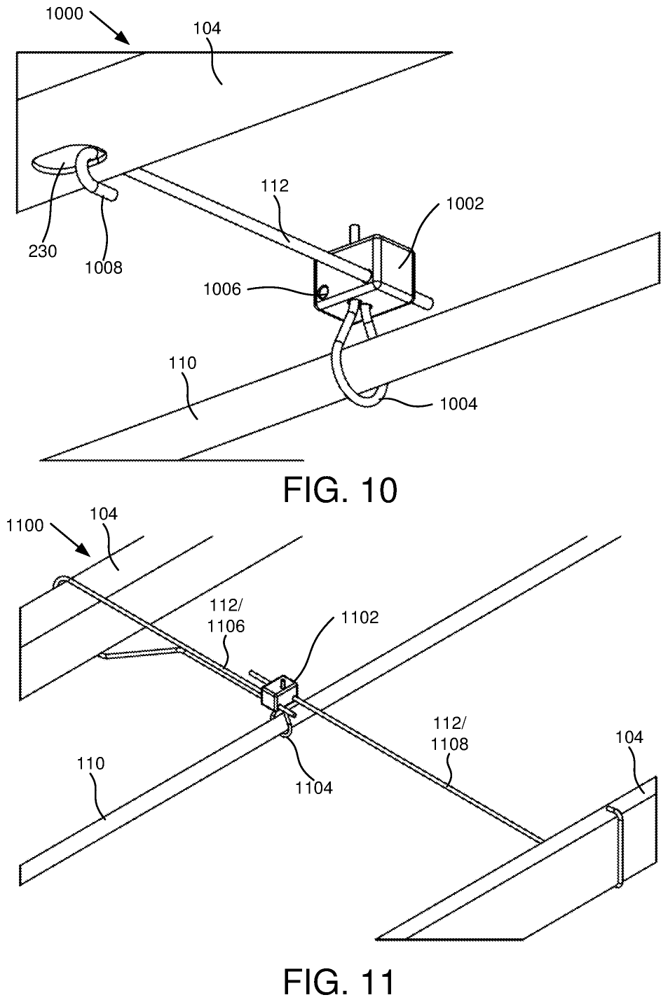

FIG. 10 is a partial bottom perspective view 1000 of a frame 104 of a panel 102 with a spanning member 112 connected to a three-hole tensioner 1002 with a wire support loop 1004 supporting a wire, according to various embodiments. The spanning member 112 in FIG. 10 is rigid and a bent end 1008 of the spanning member 112 extends through a hole 230 in the frame 104. The spanning member 112 extends through the three-hole tensioner 1002 that includes a first hole for the spanning member 112, a second hole 1006 for another spanning member 112, and a third hole for a wire support loop 1004. Each hole extends through the three-hole tensioner 1002 and includes a locking mechanism. The first hole with the spanning member 112 and second hole 1006 have locking mechanisms that are positioned opposite each other so that as the spanning members 112 can be pushed in toward the three-hole tensioner 1002 but oppose movement of the spanning members 112 away from the three-hole tensioner 1002.

The wire support loop 1004, in some embodiments, is connected to the three-hole tensioner 1002 with another end free to loop around the wire 110 and through a third hole of the three-hole tensioner 1002. In some embodiments, a locking mechanism of the third hole allows insertion of the wire support loop 1004 but opposes pulling the wire support loop 1004 in a direction toward the wire 110, which would loosen the wire support loop 1004 from around the wire 110.

FIG. 11 is a partial perspective top view 1100 of a panel frame with two spanning members 1106, 1108 connected to a three-hole tensioner 1102 with a wire support loop 1104 supporting a wire 110, according to various embodiments. The first and second spanning members 1106, 1108 are substantially similar to the spanning members 112, 212 described above and may be rigid or flexible. In the embodiment, a first spanning member 1106 is flexible and wraps around a frame 104 of a panel 102, which may be a solar panel. In some embodiments, the panel 102 and frame 104 are substantially similar to the panel and frame of FIGS. 1A, 1B, 2A, 2B, 3A, 3B, 4A, 4B, 6A-D, and/or 10.

In some embodiments, the first spanning member 1106 has an end connected to the frame 104 and wraps around the frame 104 and has an end inserted into a first hole of the three-hole tensioner 1102, which includes a locking mechanism. In some embodiments, the three-hole tensioner 1102 of FIG. 11 is similar to the three-hole tensioner 1002 of FIG. 10 but includes a flexible first spanning member 1106 connected to the housing of the three-hole tensioner 1102. The second spanning member 1108 is depicted as rigid and has a portion wrapped around the frame 104. The second spanning member 1108 is inserted into a second hole of the three-hole tensioner 1102, which includes a locking mechanism. In other embodiments, the second spanning member 1108 is also flexible with an end connected to the housing, the same as the first spanning member 1106.

In some embodiments, the three-hole tensioner 1102 includes a wire support loop 1104 with an end connected to the housing of the three-hole tensioner 1102 and wrapped around a wire 110 and then the wire support loop 1104 is inserted into a third hole of the three-hole tensioner 1102, which includes a locking mechanism. In some embodiments, the three-hole tensioner 1102 is connected to the frame 104 using the first and second spanning members 1106, 1108 with an adequate amount of tension put on the spanning members 1106, 1108. The wire support loop 1104 is then used to secure a wire 110. The three-hole tensioners 1002, 1102, in some embodiments, have a housing, a covering, a locking member, etc. as described in the '683 application and the '634 application.

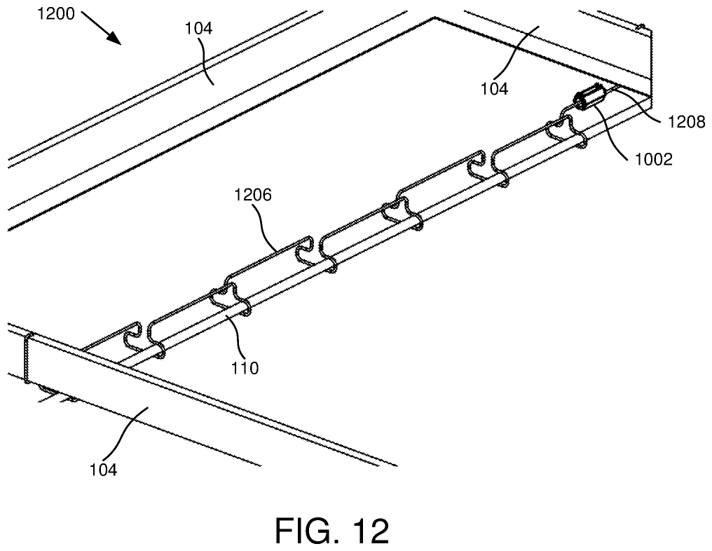

FIG. 12 is a partial perspective top view 1200 of a frame 104 of a panel 102 with a spanning member 1206 shaped as a wire hanger supporting a wire 110, according to various embodiments. In the embodiments, a first spanning member 1206 is rigid with an end wrapping around a frame 104 of a panel 102, which may be a solar panel. In some embodiments, the panel 102 and frame 104 are substantially similar to the panel and frame of FIGS. 1A, 1B, 2A, 2B, 3A, 3B, 4A, 4B, 6A-D. 10, and/or 11. The first spanning member 1206 is shaped to be a wire hanger so that a wire 110 can be placed in supporting loops of the first spanning member 1206. An end of the first spanning member 1206 is inserted into a two-hole tensioner 1202. A second spanning member 1208 is also rigid with one end wrapped around the frame 104 and another end inserted into a second opening of the two-hole tensioner 1202. Each of the holes in the two-hole tensioner 1202 extend through a housing of the two-hole tensioner 1202 and each hole has a locking mechanism so that pushing the first and second spanning members 1206, 1208 through the two-hole tensioner 1202 adds tension to the first and second spanning members 1206. The two-hole tensioner 1202, in some embodiments, has a housing, a covering, a locking member, etc. as described in the '683 application and the '634 application.

While various embodiments described and depicted herein refer to a spanning member 112, 212, 312, 412, 413, 1106, 1108, 1206 connected between a first spanning member connection point 118 and a second spanning member connection point 120 connected to a mounting clip 114, 116 or directly to a frame 104 of a panel 102, 202, the embodiments described herein are not s limited. In other embodiments, a spanning member 112, 212, 312, 412, 413, 1106, 1108, 1206 may connect to first and second spanning member connection points 118, 120, 218, 220 of some type of frame that is not a frame 104, 204 of a panel 102, 202 either directly or on mounting clips 114, 116, 150, 152, 500, 900. In some examples, the frame is a support structure for panels, such as mounting rails or posts holding up solar panels or other electrical panels. In other examples, the frame may be ceiling trusses above ceiling tiles, structural steel beams, etc.

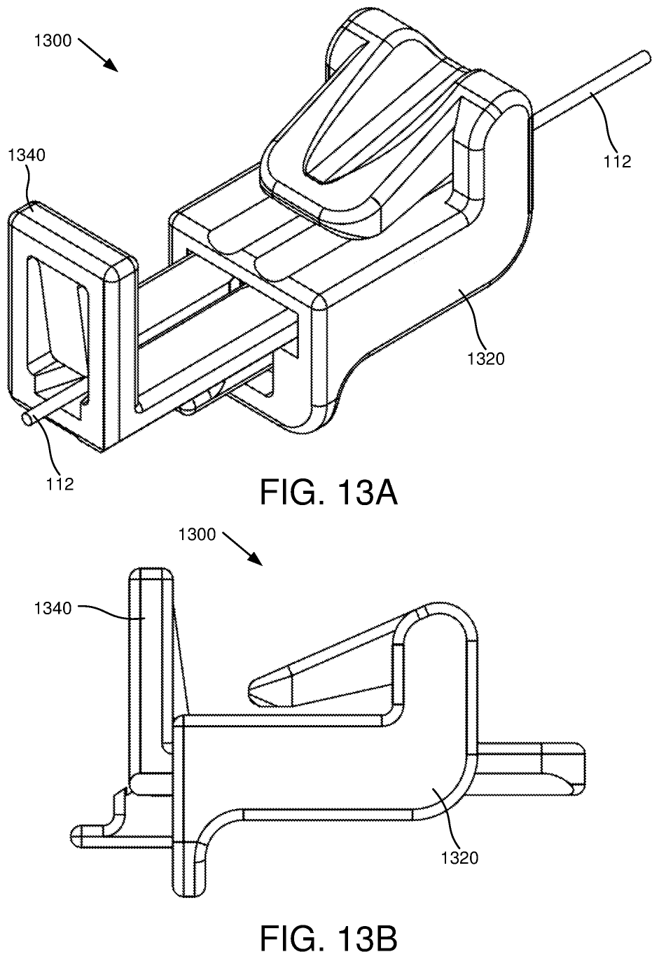

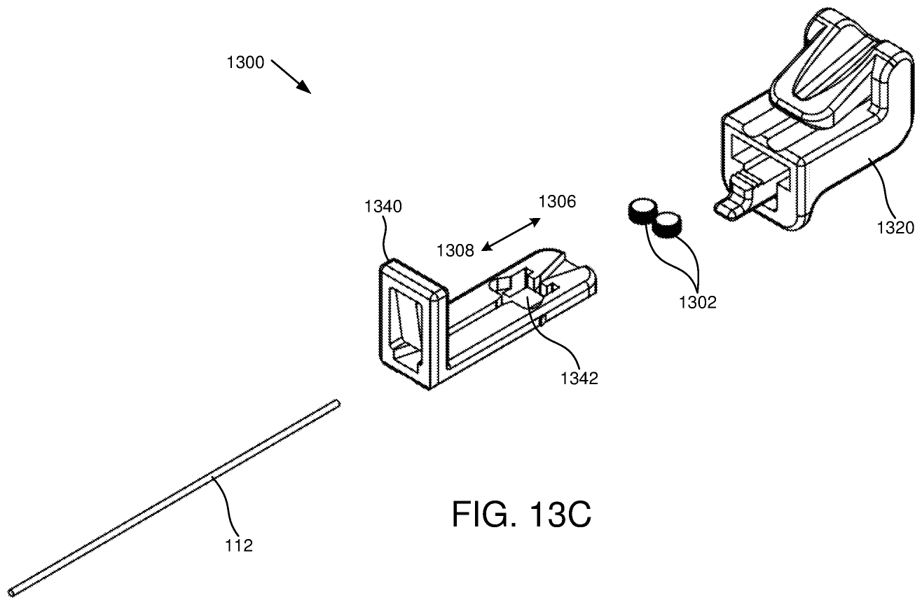

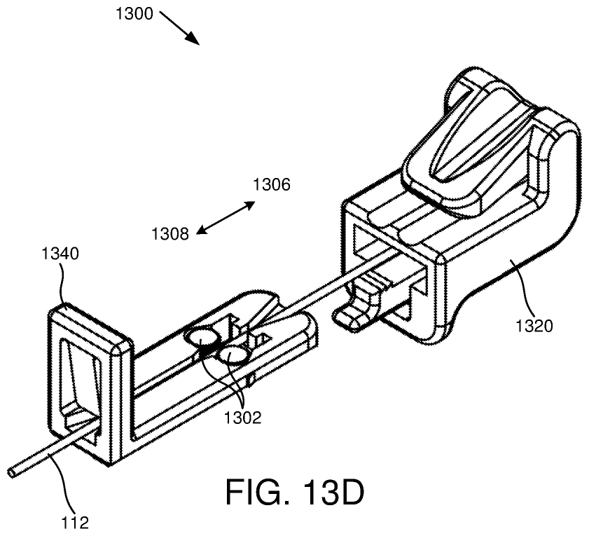

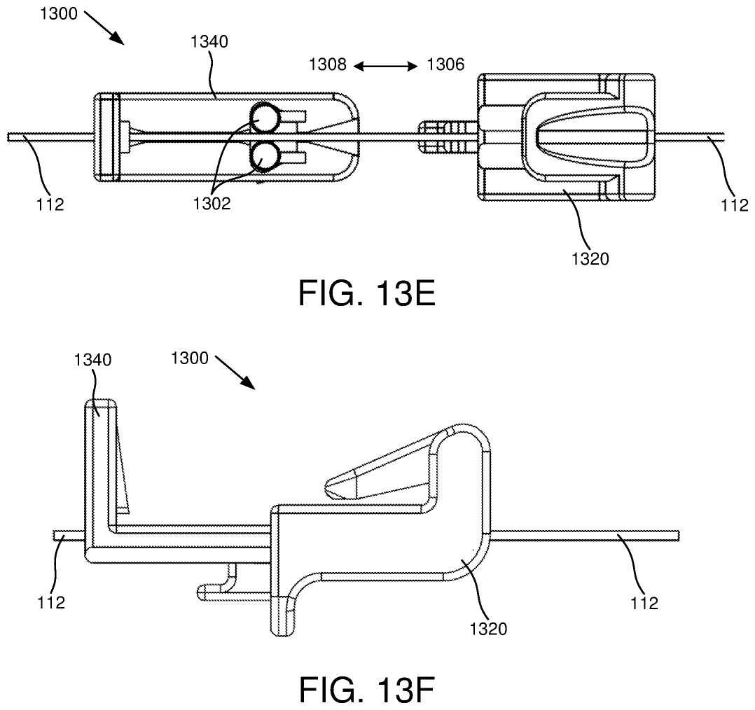

FIG. 13A is a perspective view of a mounting clip 1300 for securing a spanning member 112 to a frame (e.g. 104) of a panel (e.g., 102), according to various embodiments. FIG. 13B is a side view of the mounting clip 1300 of FIG. 13A, according to various embodiments.

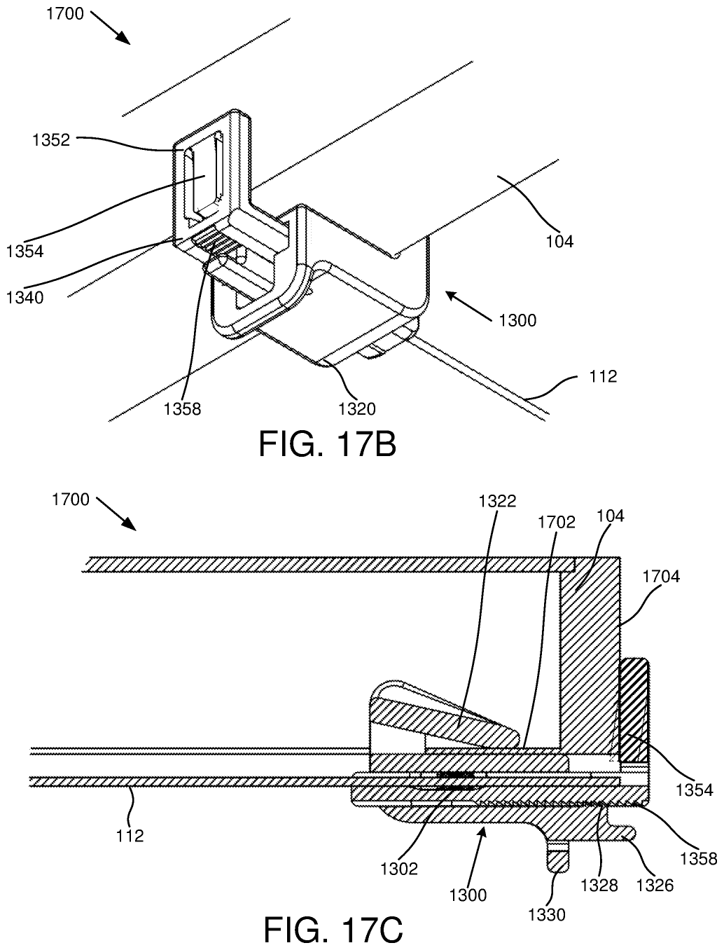

The mounting clip 1300 includes an inner clip 1320 and an outer clip 1340. The outer clip 1340 and inner clip 1320 are operable to clamp onto a frame 104 of a panel 102. The outer clip 1340 is intended to rest against an outer side (vertical portion 1704 of FIG. 17C) of a frame 104 and the inner clip 1320 is intended to couple to an inner edge of a horizontal portion 1702 (see FIG. 17C) of the frame 104. FIG. 13A depicts the mounting clip 1300 in an open position where the outer clip 1340 is in an expanded position and pulled out to a stopping point from the inner clip 1320. FIG. 13B depicts the mounting clip 1300 in a closed position where the outer clip 1340 is pushed into the inner clip 1320 as far as the outer clip 1340 is able to go.

A spanning member 112 is depicted inserted into the mounting clip 1300 in FIG. 13A. In some embodiments, the spanning member 112 is flexible. Where the spanning member 112 is flexible, in some embodiments, the spanning member 112 is a flexible cable. In various embodiments, the spanning member 112 is constructed using stainless-steel, galvanized steel, aluminum, or the like. In other embodiments, the flexible spanning member 112 is made of a non-metallic material, such as nylon, a polymer, carbon fiber, or other similar material. In some embodiments, the spanning member 112 includes a coating. In the embodiments, the coating includes a plastic, a polymer, a rubber, or the like. In other embodiments, the spanning member 112 is rigid. In the embodiments, the rigid spanning member 112, such as the spanning member 1206 of FIG. 12 or other rigid spanning member 112 as described above.

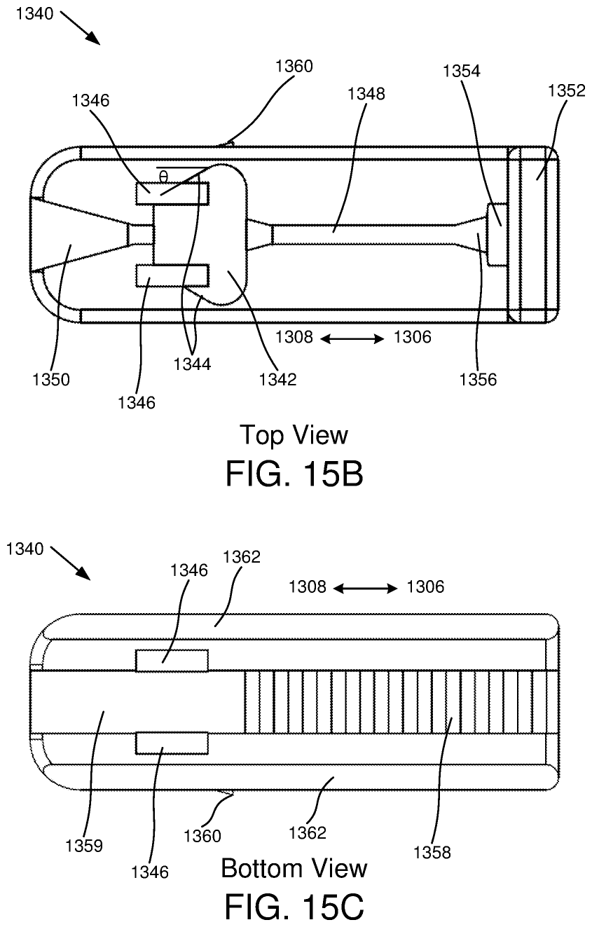

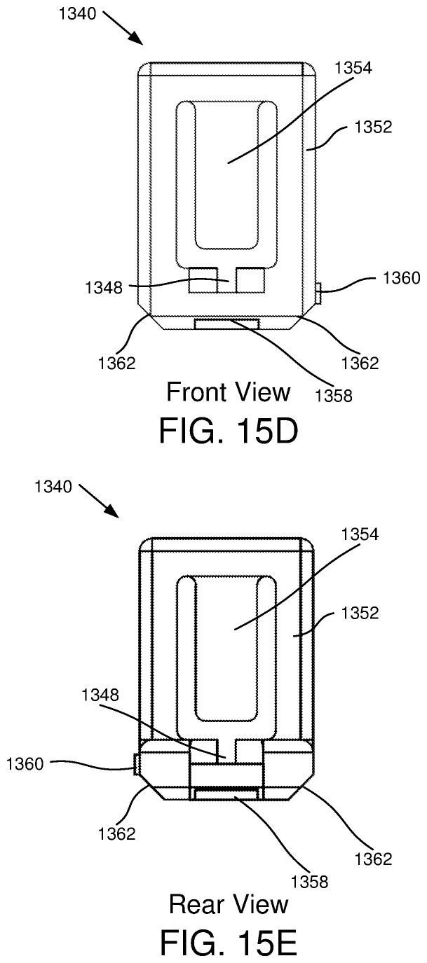

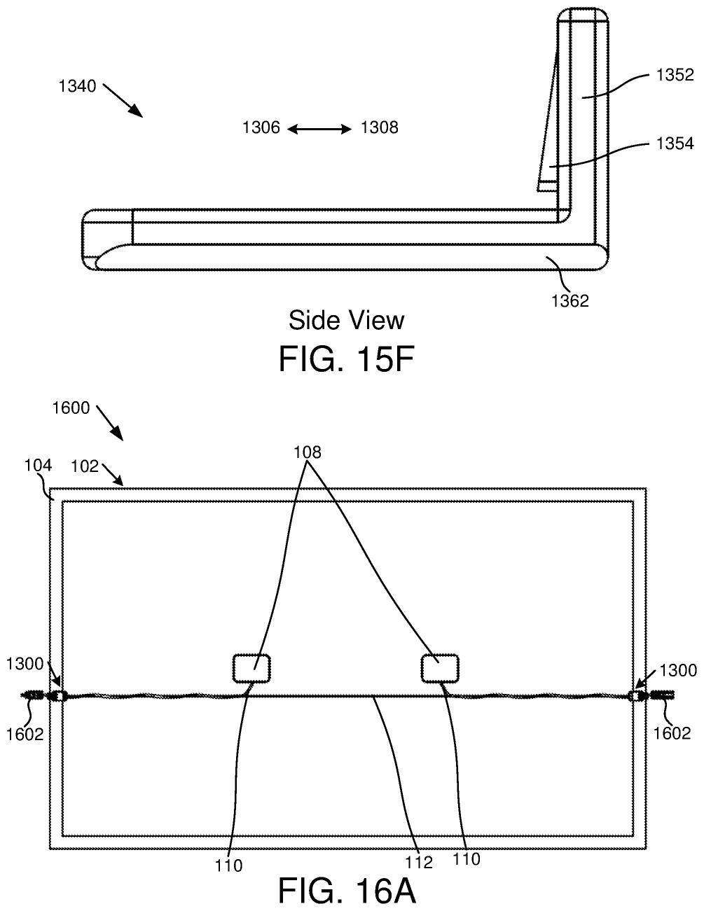

FIG. 13C is an exploded perspective view of the mounting clip 1300 of FIG. 13A, according to various embodiments. The mounting clip 1300 includes two rollers 1302 in a roller compartment 1342 of the outer clip 1340. The roller compartment 1342 is designed to wedge the rollers 1302 against the spanning member 112 and to resist movement of the spanning member 112 when the spanning member 112 is moved in a first direction 1306 (right) and to allow the spanning member 112 to move through the mounting clip 1300 when the spanning member 112 is moved in a second direction 1308 (left) opposite the first direction 1306. In some embodiments, the rollers 1302 are textured. The shape of the roller compartment 1342 is discussed in further detail with respect to a description of the outer clip 1340 in FIGS. 15A-F.

FIG. 13D is a perspective view and FIG. 13E is a top view of the partially assembled mounting clip 1300 of FIG. 13A, according to various embodiments. FIG. 13D depicts the rollers 1302 in the outer clip 1340 and the outer clip 1340 is ready to be pressed into the inner clip 1320. The spanning member 112 is depicted to show where the spanning member 112 fits within the outer clip 1340 and inner clip 1320.

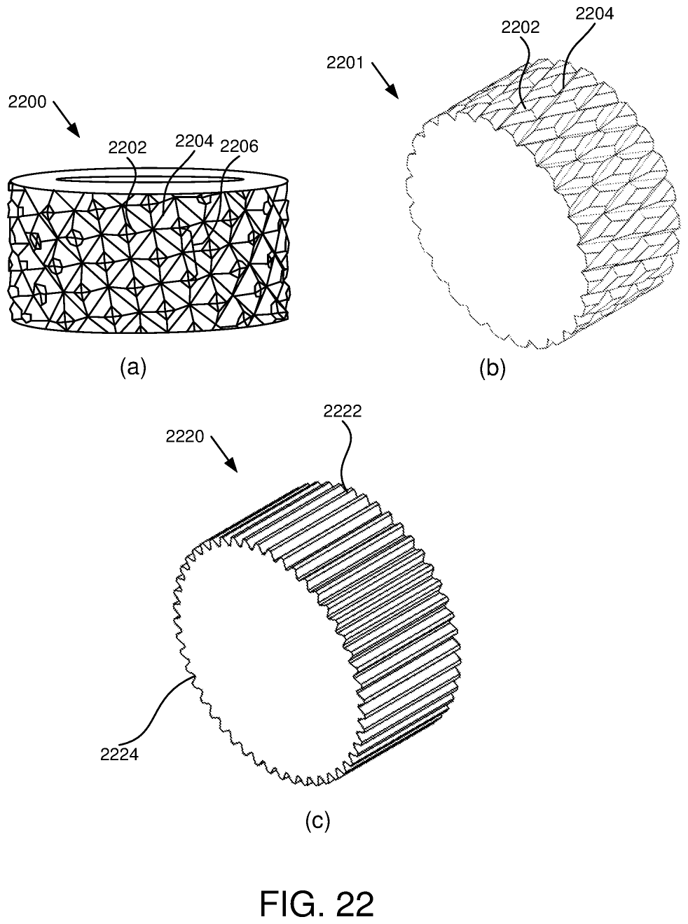

In some embodiments, the rollers 1302 are textured rollers that have a textured surface that contacts the spanning member 112. The textured surface is configured to have a higher resistance than a smooth surface. In some embodiments, the textured rollers 1302 have a rough surface and/or an irregular surface. The rough/irregular surface, in some embodiments, is caused by some type of abrasion, such as sand blasting, etching, etc. In other embodiments, the textured rollers 1302 have a rough surface that is regular. In some examples, the rough surface is caused by stamping, cutting, machining, etc. In some embodiments, the textured surface is a knurled surface using a knurled pattern. In various embodiments, the knurled pattern has raised areas. Experimentation has shown that when using a cable as a spanning member 112, pointed tips on the raised areas contributes to stripping a coating on the and/or slippage of some types of cable. In some embodiments, the raised areas include a top with a divot, as depicted in FIG. 22(a). In other embodiments, the raised areas include a flat top or a rounded top. In various embodiments, the raised areas include a rounded top, a flat top, and/or a top with a divot.

FIG. 13F is a side view of the mounting clip 1300 of FIG. 13A, according to various embodiments. FIG. 13F depicts the outer clip 1340 inserted into the inner clip 1320 but still in an open position ready to be clamped around a frame 104. Again the spanning member 112 is shown to provide a perspective of where the spanning member 112 fits within the mounting clip 1300.

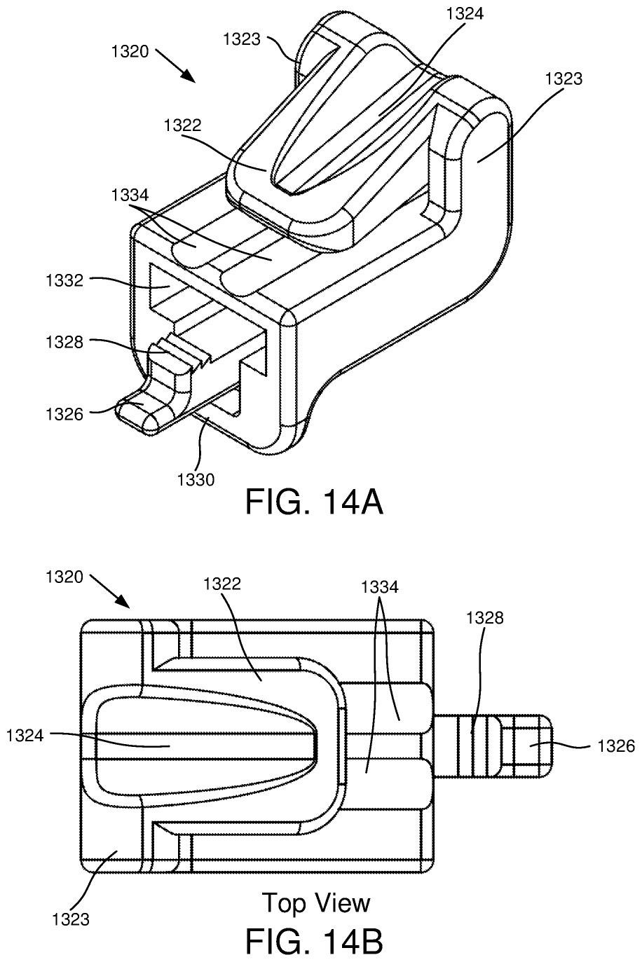

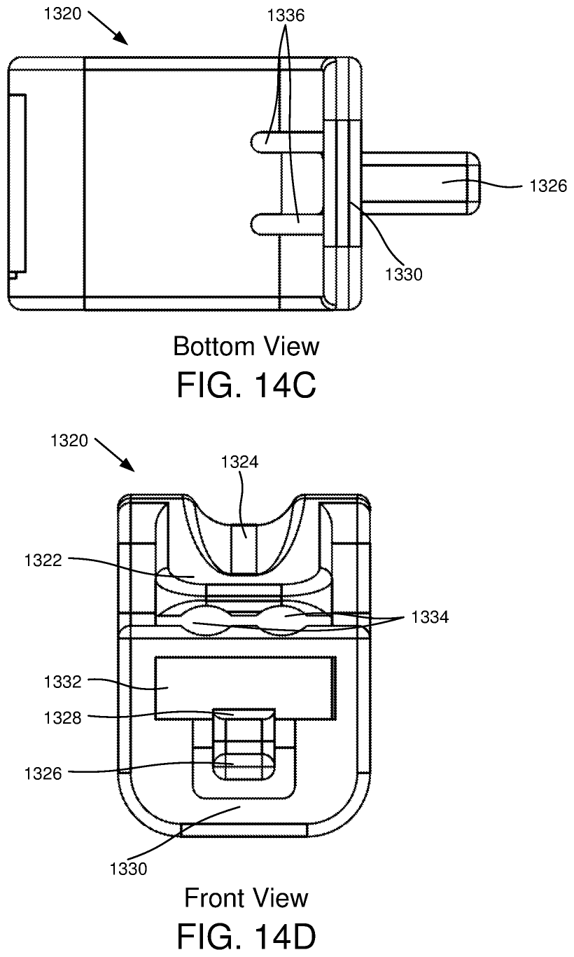

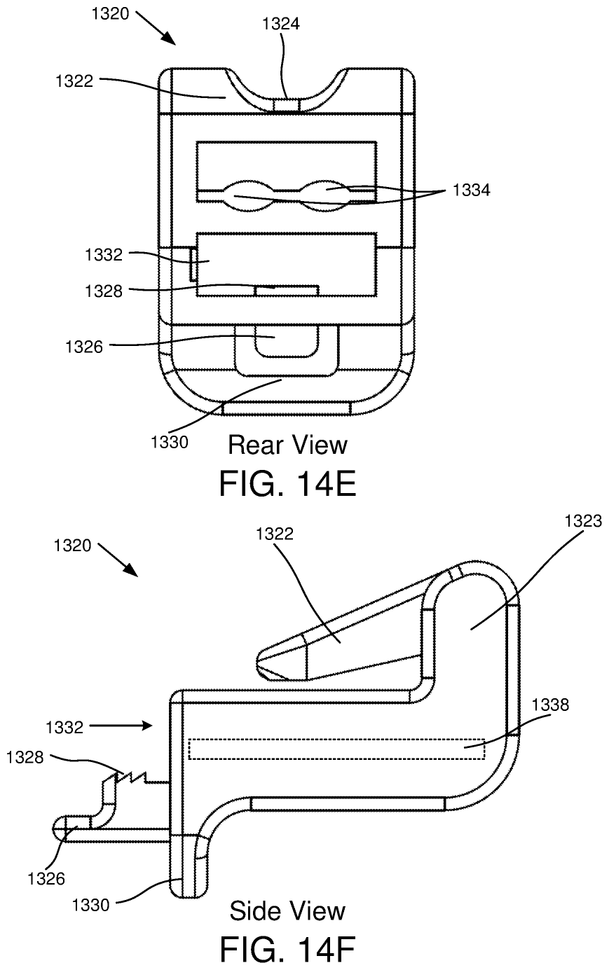

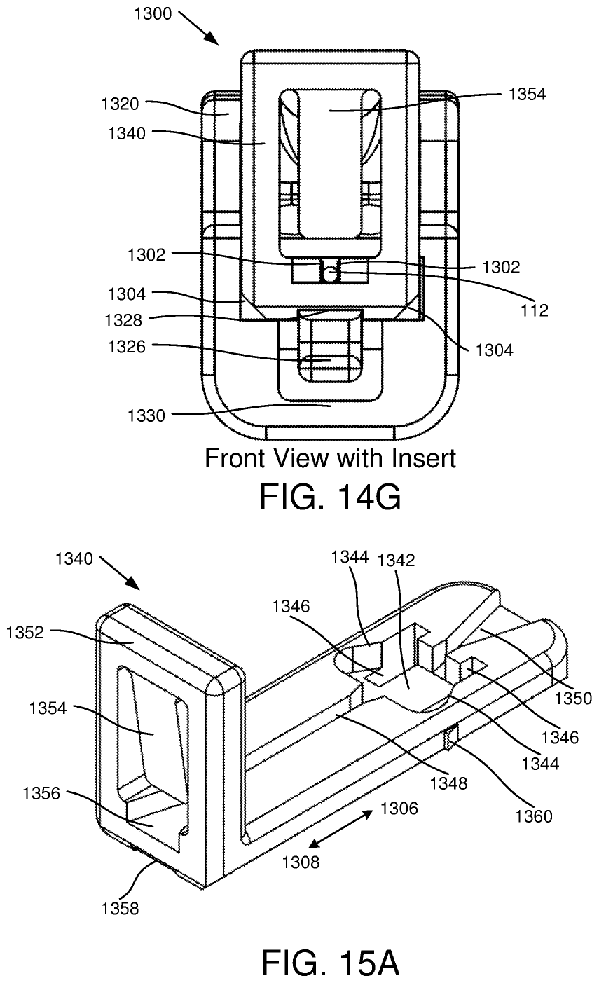

FIG. 14A is a perspective view, FIG. 14B is a top view, FIG. 14C is a bottom view, FIG. 14D is a front view, FIG. 14E is a rear view, Figure and 14F is a side view of the inner clip 1320 of the mounting clip 1300 of FIG. 13A, according to various embodiments. In some embodiments, the frame 104, as depicted in FIGS. 1A, 1B, 6D, and 17C, includes a horizontal portion 1702 and a vertical portion 1704 coupled to the horizontal portion. The inner clip 1320 includes a frame clip 1322 configured to engage an edge of the horizontal portion 1702 of the frame 104, as depicted in FIG. 17C. In some embodiments, the frame clip 1322 engages the horizontal portion 1702 of the frame 104 by sliding over an edge of the horizontal portion 1702 opposite to where the horizontal portion 1702 couples to the vertical portion 1704.

In some embodiments, the frame clip 1322 extends from a vertical arm 1323 and the frame clip 1322 is angled downward, as depicted in FIG. 14F, with a narrow opening at an end opposite to connection to the vertical arm 1323. In some embodiments, the frame clip 1322 slides over the edge of the horizontal portion 1702 of the frame 104 with a friction fit. In some embodiments, the frame clip 1322 exerts a spring force onto the horizontal portion 1702 of the frame 104 and the frame clip 1322 is made of a resilient material and is shaped to include the spring force. While the frame clip 1322 is depicted to be internal to vertical arms 1323, which may be to reduce material of the inner clip 1320, in other embodiments the frame clip 1322 is as wide as the vertical arms 1323.

In embodiments depicted in FIGS. 14A, 14B, 14D, and 14E, the frame clip 1322 includes a groove 1324, which may be a result of tooling and/or to remove excess material. In addition, the inner clip 1320 may include other grooves 1334 created for tooling, reducing material used in the mounting clip 1300, etc. In some embodiments, the grooves 1324, 1334 are used to maintain a particular wall thickness of the mounting clip 1300.

In some embodiments, the outer clip 1340 includes locking teeth 1358 (see FIGS. 15C-E) and the inner clip 1320 includes a clip release lever 1326 connected to opposing teeth 1328. The locking teeth 1358, in some embodiments, are arranged in a row in a direction that the outer clip 1340 slides through the inner clip 1320 and opposing teeth 1328 of the inner clip 1320 are positioned to mate with the locking teeth 1358 and to oppose sliding the outer clip 1340 away from the inner clip 1320. The clip release lever 1326 is configured, in some embodiments, to disconnect the opposing teeth 1328 from the locking teeth 1358 upon application of a force on the clip release lever 1326. The application of force on the clip release lever 1326 is in a direction away from the outer clip 1340 when the locking teeth 1358 are engaged with the opposing teeth 1328.

In some embodiments, the inner clip 1320 includes a limiter loop 1330 located to prevent the clip release lever 1326 from over-extending and being damaged. In some embodiments, the limiter loop 1330 is located a prescribed distance from the clip release lever 1326 where the prescribed distance is enough to allow the clip release lever 1326 to disengage the opposing teeth 1328 from the locking teeth 1358 of the outer clip 1340 and the prescribed distance is short enough to prevent the clip release lever 1326 from breaking off or being damaged. In some embodiments, the location of the limiter loop 1330 is based on a length of the clip release lever 1326, an amount of flex of the clip release lever 1326 to disengage the opposing teeth 1328 from the locking teeth 1358, flexibility of material used in construction of the clip release lever 1326 and/or the inner clip 1320.

The inner clip 1320 includes an opening 1332 configured to conform to a shape of a portion of the outer clip 1340 configured to slide into the inner clip 1320. In some embodiments, the opening 1332 has a rectangular cross section sized just larger than a corresponding rectangular section of the outer clip 1340 that fits in the inner clip 1320.

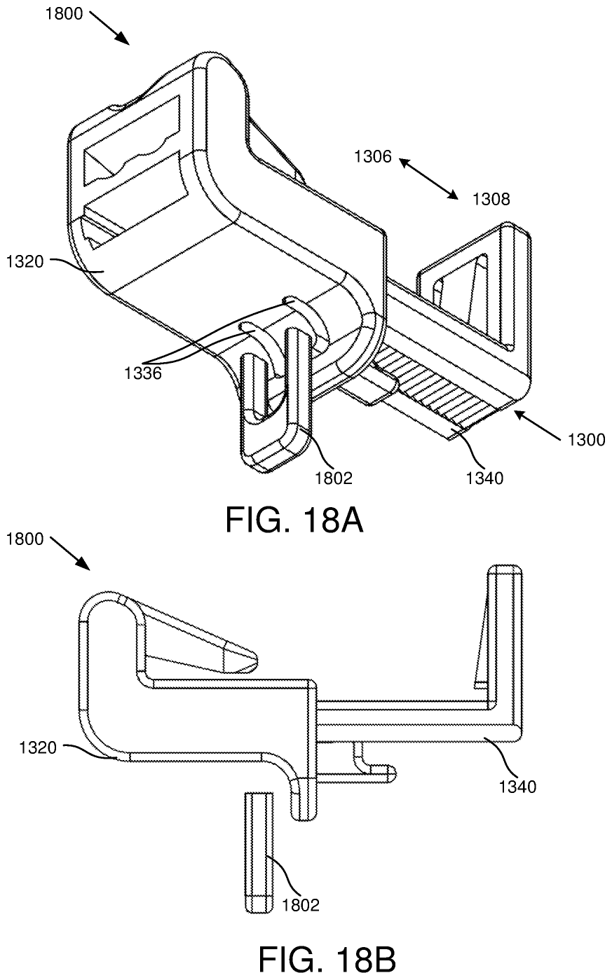

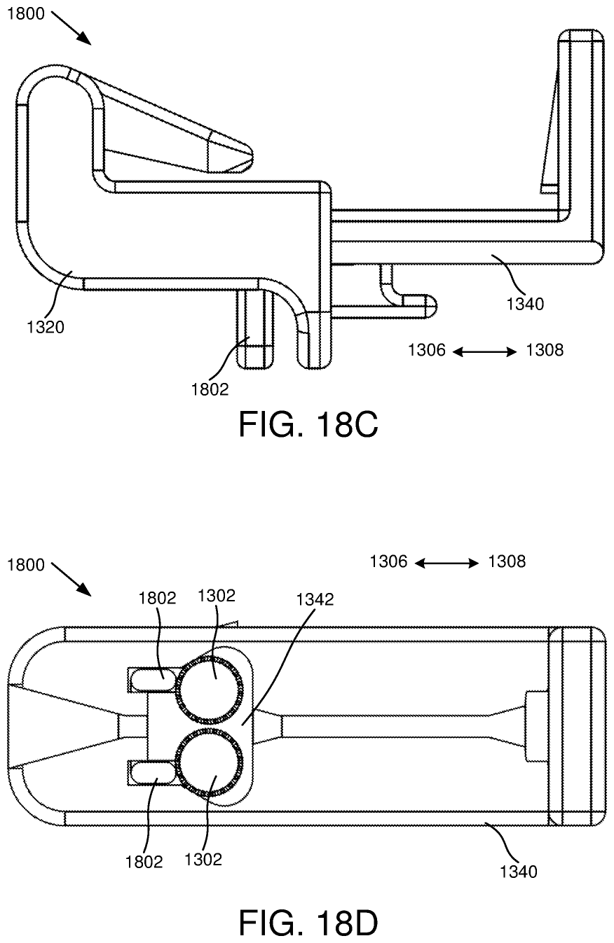

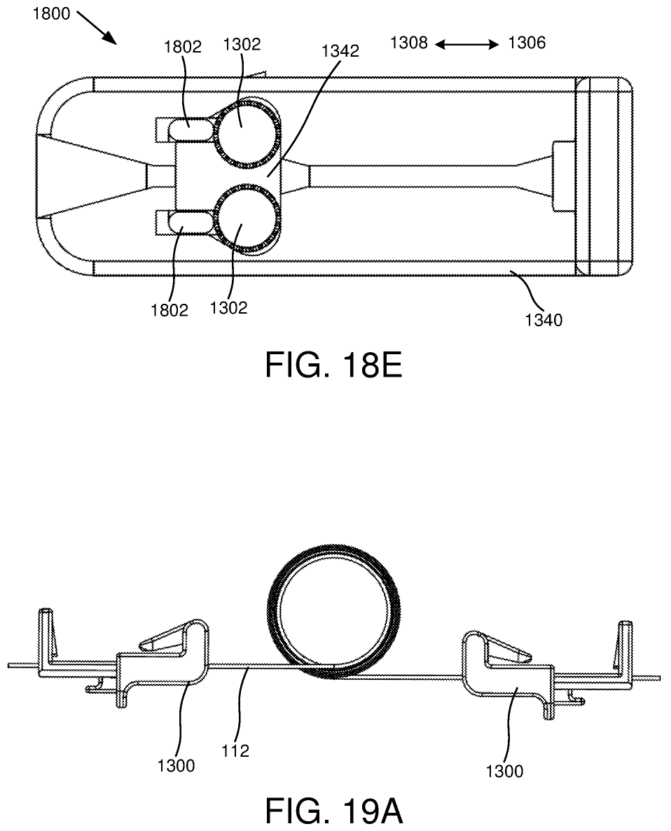

In some embodiments, the inner clip 1320 includes one or more roller release holes 1336 configured to accommodate a roller release tool 1802 (as depicted in FIGS. 18A-E). In some embodiments, the outer clip 1340 includes roller release holes 1346 that align with the roller release holes 1336 of the inner clip 1320 when the outer clip 1340 is positioned within the inner clip 1320 a particular amount. When the roller release holes 1336, 1346 are aligned, the roller release tool 1802 may be used to release the spanning member 112 from the rollers 1302. Use of the roller release tool 1802 is explained in more detail with regards to FIGS. 18A-E.

FIG. 14G is a front view of the inner clip 1320 of FIG. 14A with the outer clip 1340 of the mounting clip 1300 of FIG. 13A, according to various embodiments. FIG. 14G depicts the spanning member 112 a spanning member channel and between two textured rollers 1302. FIG. 14G also depicts a slack management opening 1304 formed by the outer clip 1340 having a chamfered bottom while the opening 1332 in the inner clip 1320 for the outer clip 1340 is squared so that a triangle-shaped slack management opening 1304 is formed. The slack management opening 1304 extends through the mounting clip 1300 and allows a slack end of the spanning member 112 that is flexible to extend through the mounting clip 1300.

FIG. 15A is a perspective view, FIG. 15B is a top view, FIG. 15C is a bottom view, FIG. 15D is a front view, FIG. 15E is a rear view, and FIG. 15F is a side view of the outer clip 1340 of the mounting clip 1300 of FIG. 13A, according to various embodiments. The outer clip 1340, in some embodiments, includes a roller compartment 1342 configured to hold two rollers 1302 positioned to be on either side of the spanning member 112, as depicted in FIGS. 13D and 13E. The roller compartment 1342 includes an angled side 1344 positioned to be adjacent to each of the two rollers 1302. The angled sides 1344 are angled to narrow in a direction towards the inner clip 1320 in the first direction 1306.

The angled sides 1344 include a slope with an angle θ (see FIG. 15B) that is chosen to enable locking of the spanning member 112 when force is applied to the spanning member 112 in the first direction 1306 while providing minimal lash. Lash, as defined herein, is an amount of unwanted movement of the spanning member 112 in a locking direction (first direction 1306) after the spanning member 112 engages the rollers 1302 as a result of a force on the spanning member 112 in the first direction 1306. An optimum angle θ is where lash is minimized while the angle θ is low enough to maximize strength of a grip of the roller 1302 on the spanning member 112. A lower angle θ leads to more lash while a steeper angle θ leads to less lash. However, as the angle θ of the angled sides 1344 increases, the rollers 1302 eventually lose effectiveness and fail to wedge against the spanning member 112. In addition, a high angle of the angled sides 1344 may also lead to damage to the spanning member 112, especially when the spanning member 112 is a coated cable where the coating may be damaged.

In some embodiments, the angle of each of the angled sides 1344 is in a range of 10 degrees to 35 degrees. In other embodiments, the angle of each of the angled sides 1344 is in a range of 27 degrees to 33 degrees. Experimentation has shown that an optimum angle θ of the angled sides 1344 is about 30 degrees when the spanning member 112 is a steel cable with a plastic coating. In some embodiments, the slope of the angled sides 1344 are designed to include a specified amount of lash, such as 0.3 millimeters. A specified amount of lash is useful to relax the spanning member 112 enough to avoid damage to a coating on the spanning member 112.

Where a single roller 1302 is used, the angled sides 1344, in some embodiments, have an angle θ in a range of about 10 degrees to 35 degrees, but may be in a range of 18 degrees to 22 degrees. For embodiments, with a single roller 1302, an optimum angle θ of the angled side 1344 is lower, such as 20 degrees, based on experimentation. A pattern of the textured rollers 1302, a size of the spanning member 112, material of the spanning member 112, a material of the coating, and the like affect the optimum angle θ as well as damage to the spanning member 112 due to the textured rollers 1302.

In the embodiments with a roller compartment 1342 with a single roller 1302, the roller 1302 may be textured, and the roller compartment is shaped with a single angled side 1344. In the embodiments, the single roller 1302 wedges the spanning member 112 against a wall of the roller compartment 1342. With a single roller 1302, the wall where the spanning member 112 is wedged, in some embodiments, includes a channel sized and located to maintain the spanning member 112 centered on the roller 1302 and has a depth so that deformation of the spanning member 112 allows the roller 1302 to not touch against the walls of the roller compartment 1342 surrounding the channel, which decreases grip strength on the spanning member 112. In some embodiments, the channel depth is about one-third of the diameter of the spanning member 112. In other embodiments, the depth of the channel is in a range of about 50 percent to 5 percent of the diameter of the spanning member 112.

In some embodiments, the outer clip 1340 includes roller release holes 1346 to accommodate a roller release tool 1802, which is discussed in further detail below in relation to FIGS. 18A-E. In other embodiments, the outer clip 1340 includes a spanning member channel 1348 configured to guide the spanning member 112 through the outer clip 1340 and roller compartment 1342 between the roller(s) 1302. In some embodiments, three sides of the spanning member channel 1348 are formed by the outer clip 1340 with a fourth side formed by a side of the opening 1332 in the inner clip 1320.

A width and a height of the spanning member channel 1348 are sized to accommodate a diameter of the spanning member 112. In some embodiments, the width and height of the spanning member channel 1348 are chosen to facilitate easy movement of the spanning member 112 in the spanning member channel 1348 while guiding the spanning member 112 precisely through the rollers 1302 and/or the outer clip 1340. In some examples, a diameter of the spanning member channel 1348 is sized in a range of about 2 percent to 25 percent larger than a diameter of the spanning member 112. In some embodiments, the spanning member channel 1348 is sized in a range of about 5 percent to 10 percent larger than a diameter of the spanning member 112. Size of the spanning member channel 1348 accounts for resistance of an outer shape and coating of the spanning member 112 and resistance of a material of the outer clip 1340.

In some embodiments, the spanning member channel 1348 is square or rectangular. In other embodiments, the spanning member channel 1348 is shaped to conform to an outer shape of the spanning member 112 and may be rounded or U-shaped within the outer clip 1340. In the embodiment, the outer clip 1340 has an open top of the spanning member channel 1348 and roller compartment 1342 to allow easy placement of the roller(s) 1302 and to facilitate easier construction of and tooling for the outer clip 1340.

In some embodiments, the spanning member channel 1348 of the outer clip 1340 includes a widened entrance 1350 to facilitate easier input of the spanning member 112 into the spanning member channel 1348. Width and depth of the widened entrance 1350 are chosen based on depth of the roller compartment 1342 within the outer clip 1340 and width of the outer clip 1340. In some embodiments, the spanning member channel 1348 includes a widened exit 1356, which may allow movement of a slack end of the spanning member 112.

In some embodiments, the outer clip 1340 includes a frame stop 1352 extending vertically with respect to the spanning member channel 1348 and the first and second directions 1306, 1308. The frame stop 1352 is configured to engage the vertical portion 1704 of the frame 104. A height of the frame stop 1352 above a horizontal portion of the outer clip 1340 is chosen to provide an adequate amount of bracing against the frame 104 when the outer clip 1340 is slid into the inner clip 1320 around the frame 104, as depicted in FIG. 17C.

In some embodiments, the height of the frame stop 1352 is greater than an unwanted but anticipated rotational movement of the mounting clip 1300 when installed onto the frame 104. For example, where the frame clip 1322 is angled with a gap that is wider towards the vertical arms 1323, an amount of rotational movement of the mounting clip 1300 may occur during placement of the mounting clip 1300 and/or after tightening of the mounting clip 1300 against the frame 104. In some embodiments, the height of the frame stop 1352 is at least 50 percent more than any anticipated rotational movement of the mounting clip 1300. In some embodiments, the height of the frame stop 1352 is at least twice the amount of anticipated rotational movement of the mounting clip 1300.

In some embodiments, the frame stop 1352 includes a tensioner arm 1354 oriented towards the inner clip 1320 in the first direction 1306. The tensioner arm 1354 is configured to provide a spring force opposing movement of the frame stop 1352 towards the frame 104. In some embodiments, the tensioner arm 1354 is located in an opening within the frame stop 1352 and is connected to a side of the opening. In some embodiments, the tensioner arm 1354 is connected to a top of the frame stop 1352 opposite the widened exit 1356 of the spanning member channel 1348 and is angled inward towards the roller compartment 1342 and towards where the frame 104 would contact the tensioner arm 1354. In some embodiments, a space below the tensioner arm 1354 to a bottom of the widened exit 1356 is greater than a diameter of the spanning member 112 to allow the spanning member 112 to pass under the tensioner arm 1354 without impeding the spanning member 112 moving in the second direction 1308. In other embodiments, one or more tensioner arms 1354 are positioned on sides of vertical portions of the frame stop 1352, such as if the frame stop 1352 is in a center flanked by tensioner arms 1354.

The locking teeth 1358 and the opposing teeth 1328 each have a finite width. In some examples, the locking teeth 1358 and the opposing teeth 1328 each have a width of about 2 millimeters, which could cause the mounting clip 1300 to exert less force on the frame 104 than desired. For example, where the locking teeth 1358 and the opposing teeth 1328 each have a width of about 2 millimeters, the mounting clip 1300 could have a side-to-side movement of up to 2 millimeters without the tensioner arm 1354. In some embodiments, a range of the tensioner arm 1354 is greater than a distance between two adjacent locking teeth 1358 of the outer clip 1340. Thus, the tensioner arm 1354 provides a way to overcome any movement of the mounting clip 1300 due to the incremental tightening of the outer clip 1340 and inner clip 1320 due to spacing between the locking teeth 1358 and/or opposing teeth 1328.

In some embodiments, the frame stop 1352 and/or tensioner arm 1354 include a substance, texture, pattern, etc. that increases resistance against the vertical portion 1704 of the frame 104. The substance may be a rubber or other high resistance substance. In other embodiments, the frame stop 1352 and/or tensioner arm 1354 have ridges, protrusions, etc. to increase resistance against the vertical portion 1704 of the frame 104.

In some embodiments, the outer clip 1340 includes a retainer tooth 1360 and the inner clip 1320 includes a retainer channel 1338 positioned to limit movement of the outer clip 1340 to a particular range. In some embodiments, the retainer tooth 1360 and edge of the retainer channel 1338 closest to the opposing teeth 1328 are positioned to limit travel of the outer clip 1340 in the opening 1332 to prevent the rollers 1302 from falling out of the roller compartment 1342 and/or from being visible. In other embodiments, the edge of the retainer channel 1338 closest to the opposing teeth 1328 are positioned to limit travel to a specified range adequate to clamp onto a frame 104.

In some embodiments, the retainer tooth 1360 is angled as depicted and extends outward a particular distance to allow the outer clip 1340 to be press fit into the opening 1332 of the inner clip 1320 while being able to limit movement of the outer clip 1340 when the retainer tooth 1360 is within the retainer channel 1338. In some embodiments, the outer clip 1340 is pressed into the opening 1332 of the inner clip 1320 with difficulty due to a tight fit and once the retainer tooth 1360 is in the retainer channel 1338, the retainer tooth 1360 hits at least one end of the retainer channel 1338 to limit travel of the outer clip 1340 within the opening 1332. In other embodiments, the retainer tooth 1360 flexes inward while the outer clip 1340 is pressed into the opening 1332 and then returns to an unflexed state when the retainer tooth 1360 is within the retainer channel 1338. In other embodiments, the retainer tooth 1360 is angled, as depicted in FIGS. 15A-C to facilitate pressing the outer clip 1340 into the opening 1332 of the inner clip 1320.

In some embodiments, the outer clip 1340 includes locking teeth 1358 at least along a pathway on a side of the outer clip 1340 passing the opposing teeth 1328 of the inner clip 1320. In some embodiments, the locking teeth 1358 are in a range corresponding to an open position where the retainer tooth 1360 engages the end of the retainer channel 1338 closest to the opposing teeth 1328. In some embodiments, the outer clip 1340 does not have locking teeth 1358 in a section 1359 of a track that passes over the opposing teeth 1328 of the inner clip 1320, as depicted in FIG. 15C, which beneficially reduces tooling complexity and allows free movement of the outer clip 1340 in the opening 1332 of the inner clip 1320 during initial insertion. In other embodiments, the outer clip 1340 includes locking teeth 1358 along the entire track that passes over the opposing teeth 1328 of the inner clip 1320.

In some embodiments, the outer clip 1340 includes angled edges 1362 shaped to provide a slack management opening 1304 for a slack end of the spanning member 112, as depicted in FIG. 14G. in some embodiments, the angled edges 1362 span an entire length of the outer clip 1340 to allow the slack end of the spanning member 112 to pass all the way through the mounting clip 1300. In some embodiments, the angled edges 1362 are straight, as depicted in FIGS. 14G, 15D, and 15E. In other embodiments, the angled edges 1362 are shaped to conform to a shape of the spanning member 112.

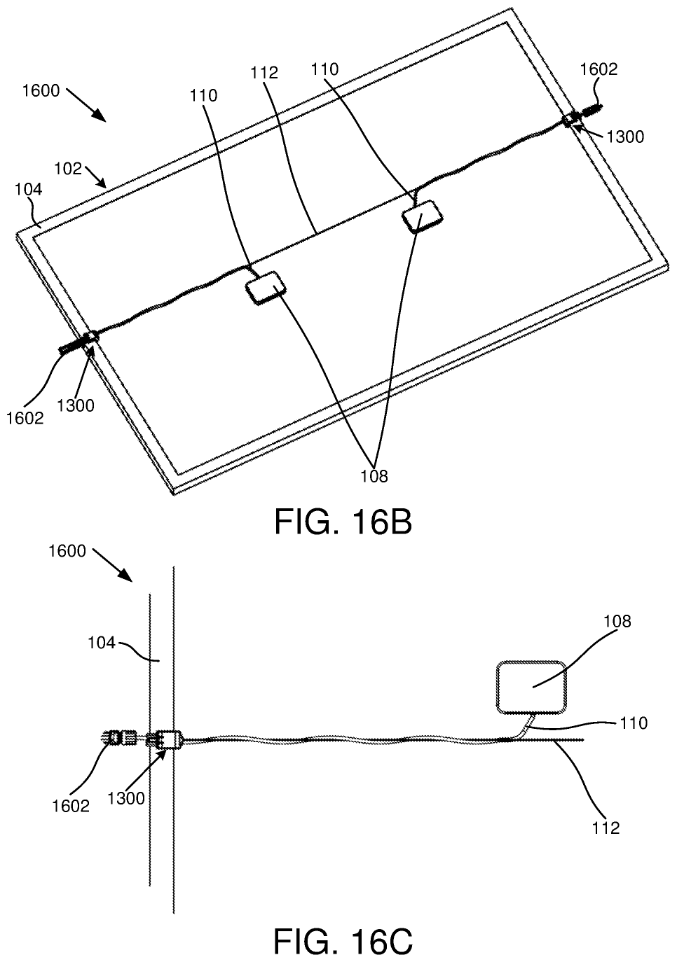

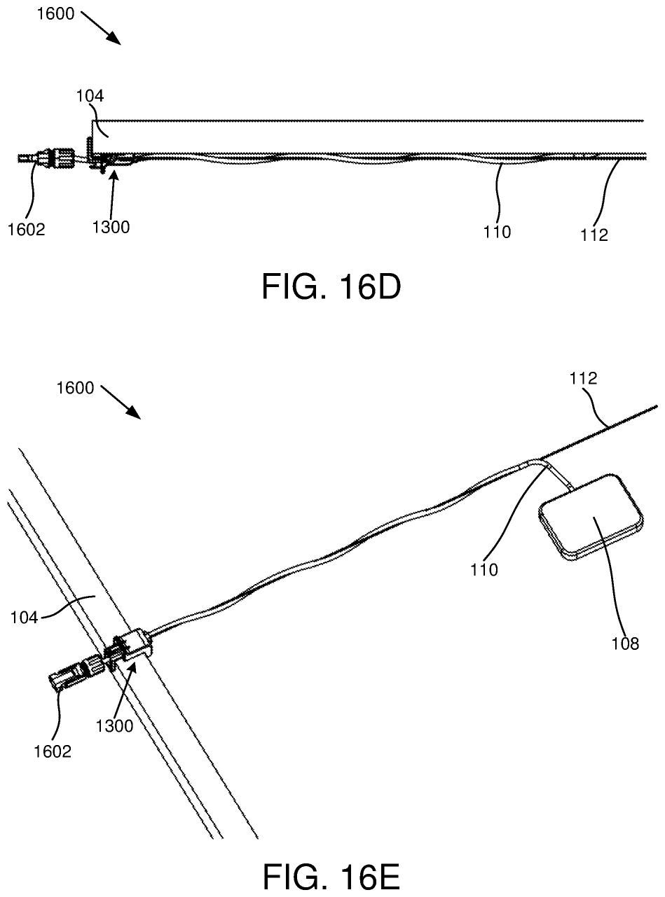

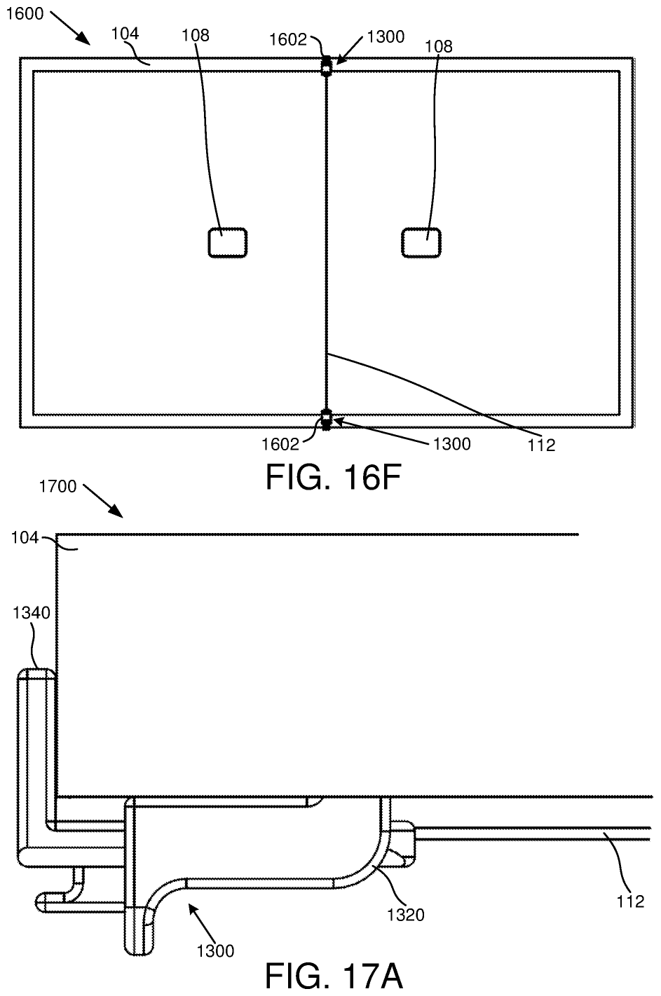

FIG. 16A is a bottom view and FIG. 16B is a bottom perspective view of an electrical system 1600 with an electrical panel 102 (e.g., panel 102) with two mounting clips 1300 of FIG. 13A and a spanning member 112 in between, according to various embodiments. FIG. 16C is a partial bottom view, FIG. 16D is a partial side view, and FIG. 16E is a partial perspective view of the electrical panel 102 of FIG. 16A with one of the two mounting clips 1300 of FIG. 13A and the spanning member 112, according to various embodiments.

FIGS. 16A-E depict one intended use for the mounting clips 1300 and spanning member 112. The panel 102 includes a frame 104 and junction boxes 108 with wiring 110 extending from the junction boxes 108. In some embodiments, the panel 102 is a solar panel, which commonly have junction boxes 108 and wiring 110 extending from the junction boxes 108. In the depicted embodiment, the wiring 110 includes a plug 1602 on each end, which may be used to connect and to wiring of an adjacent panel, to a wiring harness, etc. In other embodiments, the wiring 110 does not include plugs 1602 and the wiring may terminate at a panel, a junction box, etc.

The mounting clips 1300 are depicted mounted to a frame 104 of the electrical panel 102 with the spanning member 112 tightened between the mounting clips 1300. The spanning member 112 is then used to support the wiring 110 of the electrical panel 102. In some embodiments, the wiring 110 is wrapped around the spanning member 112. In other embodiments, the wiring 110 is supported from the spanning member 112 using clips, wires, hangers, etc.

FIG. 16F is a bottom view of an electrical panel 102 (e.g., panel 102) with two mounting clips 1300 of FIG. 13A, top and bottom, and a spanning member 112 in between, according to various embodiments. The use case of FIG. 16F is similar to the use case of FIGS. 16A-E except that the mounting clips 1300 are positioned on different sides of the electrical panel 102 than in FIGS. 16A-E. In other embodiments, the mounting clips 1300 are positioned to be offset so that the spanning member 112 is angled across the electrical panel 102. In the embodiments, the mounting clips 1300 may or may not include a gripping material on the tensioner arm 1354, frame stop 1352, and/or frame clip 1322.

FIG. 17A is a side view, FIG. 17B is a bottom perspective view, and FIG. 17C is a side section view of embodiments 1700 of the mounting clip 1300 of FIG. 13A mounted on a frame 104 of a panel 102. The frame clip 1322 is hidden by a portion of the frame 104 in FIGS. 17A and 17C, but is visible in FIG. 17C and is connected to a horizontal portion 1702 of the frame 104. In the depicted embodiment, the mounting clip 1300 is secured to a vertical portion 1704 of the frame 104 with the outer clip 1340 ratcheted into the inner clip 1320 so that the tensioner arm 1354 is moved back into the frame stop 1352 as the locking teeth 1358 move past the opposing teeth 1328 of the clip release lever 1326. The spanning member 112 is depicted as being tightened enough to extend across the frame 104 parallel to the frame 104.

FIG. 18A is a perspective view and FIG. 18B is a side view of the mounting clip 1300 of FIG. 13A and a roller release tool 1802 prior to insertion, according to various embodiments. The roller release tool 1802, in the depicted embodiments, is U-shaped with sides sized to fit into the mounting clip 1300 through the roller release holes 1336 of the inner clip 1320 and the roller release holes 1346 of the outer clip 1340 and to reach the rollers 1302 and to extend outside the mounting clip 1300 enough for a user to grasp the roller release tool 1802. In some embodiments, the roller release holes 1336, 1346 are sized so that one or more tools other than the roller release tool 1802 are able to reach the rollers 1302. In some embodiments, the one or more tools may include needle nose pliers, flat blade screw drivers, or other common tools of a user.

FIG. 18C is a side view of the mounting clip 1300 of FIG. 13A and the roller release tool 1802 of FIG. 18A after insertion so that the roller release tool 1802 extends into the roller compartment 1342 and against sides of the rollers 1302. FIG. 18D is a top view of the outer clip 1340 of the mounting clip 1300 of FIG. 13A and the roller release tool 1802 of FIGS. 18A-C after insertion and prior to release of a locking mechanism, according to various embodiments. Ends of the roller release tool 1802 are depicted against the rollers 1302. FIG. 18E is a top view of the outer clip 1340 of the mounting clip 1300 of FIG. 13A and the roller release tool 1802 after insertion and after release of a locking mechanism, according to various embodiments. In FIG. 18E, the user has moved the rollers 1302 to the right into a wider portion of the roller compartment 1342 so that the rollers 1302 are not wedged against the spanning member 112 and the spanning member 112 is able to move in the first direction 1306, thus releasing the spanning member 112. In other embodiments, the roller release holes 1336, 1346 are positioned elsewhere on the inner clip 1320 and outer clip 1340.

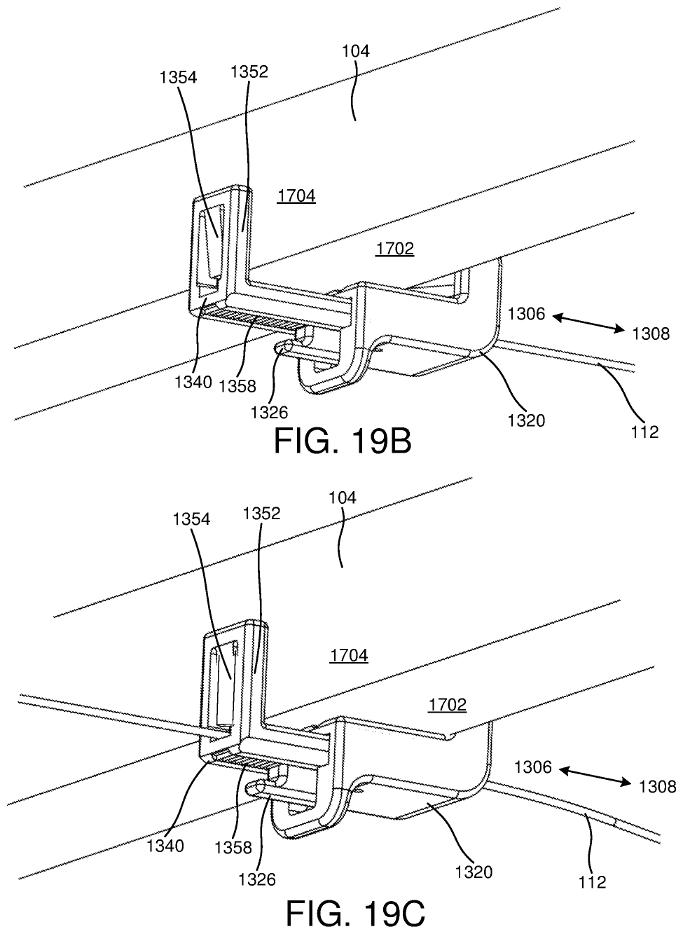

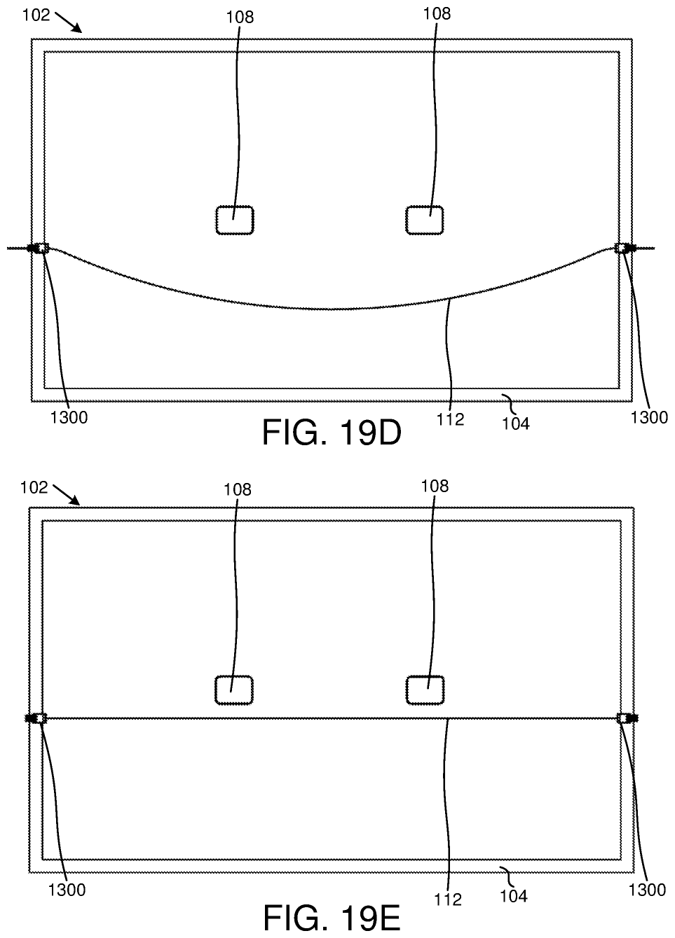

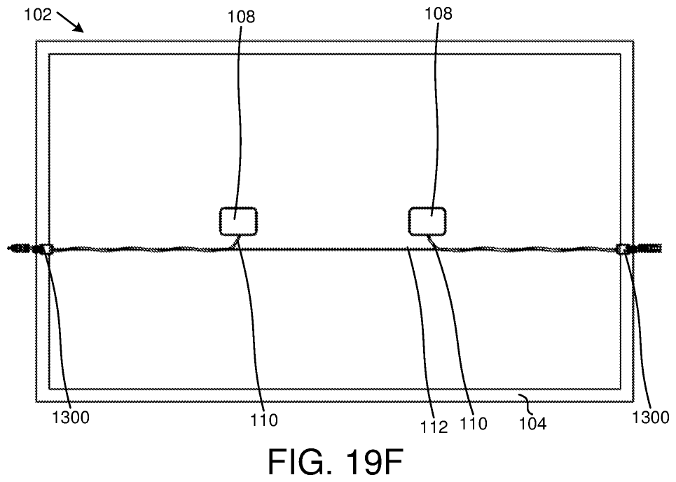

FIG. 19A is a side view of two of the mounting clips 1300 of FIG. 13A connected to a spanning member 112 in the form of a flexible cable prior to deployment on a panel 102, according to various embodiments. FIG. 19B is a perspective view of a mounting clip 1300 of the two mounting clips 1300 of FIG. 19A where the mounting clip 1300 is positioned on a frame 104 of a panel 102 prior to clamping onto the frame 104, according to various embodiments. The outer clip 1340 is in an open position with respect to the inner clip 1320, such as when the retainer tooth 1360 is extended to an end of the retainer channel 1338, or possibly moved inward enough so that the mounting clip 1300 is still positionable onto the frame 104. Initially, the frame clip 1322 of the inner clip 1320 is positioned over the horizontal portion 1702 of the frame 104 and the frame stop 1352 and tensioner arm 1354 are free to be positioned adjacent to the vertical portion 1704 of the frame 104 but not pressed tight against the frame 104.

FIG. 19C is a perspective view of the mounting clip 1300 of the two mounting clips 1300 of FIG. 19A where the mounting clip 1300 is positioned on the frame 104 of the panel 102 and is clamped onto the frame 104, according to various embodiments. The mounting clip 1300 is tightened against the frame 104 by moving the outer clip 1340 towards the inner clip 1320 so that the locking teeth 1358 move past the opposing teeth 1328 of the clip release lever 1326 until at least the tensioner arm 1354 is against the vertical portion 1704 of the frame 104. In some embodiments, the tensioner arm 1354 is only partially deflected towards the frame stop 1352 as the length of the horizontal portion 1702 of the frame 104 may not match evenly with spacing of the locking teeth 1358.

FIG. 19D is a bottom view of the panel 102 of FIGS. 19B and 19C and the two mounting clips 1300 of FIG. 19A where the spanning member 112 is not tightened, according to various embodiments. After placement of one mounting clip 1300 on one side of the frame 104 and tightening the mounting clip 1300 against the frame 104, the other mounting clip 1300, in some embodiments, is then mounted on an opposite side of the frame 104 and tightened against the frame 104. In some embodiments, the spanning member 112 is pre-inserted into the mounting clips 1300, as depicted in FIG. 19A.

In some embodiments, the spanning member 112 has cable stops or other mechanism to prevent the spanning member 112 from being pulled out of the mounting clips 1300, for example, using the roller release tool 1802. In other embodiments, ends of the spanning member 112 are inserted into the mounting clips 1300 and the rollers 1302 prevent the spanning member 112 from pulling out of the mounting clips 1300. In some embodiments, the spanning member 112 is long enough to span a longest portion of any anticipated frame 104 where the mounting clips 1300 and spanning member 112 are used. In other embodiments, the spanning member 112 is not pre-inserted into the mounting clips 1300 before clamping to the frame 104. In the embodiments, the spanning member 112 may be inserted after the mounting clips 1300 are secured to the frame 104. In some embodiments, the spanning member 112 is cut to length for the particular panel 102 where the mounting clips 1300 are installed.

FIG. 19E is a bottom view of the panel 102 of FIG. 19D and the two mounting clips 1300 of FIG. 19A where the spanning member 112 is tightened, according to various embodiments. Tightening may be accomplished by pulling one or both ends of the spanning member 112 in a direction away from a center of the panel 102 in the second direction 1308 with respect to each mounting clip 1300. In some embodiments, a slack end of the spanning member 112 extending beyond the outer clip 1340 is wrapped back around and inserted into a slack management opening 1304 of the mounting clips 1300. In other embodiments, the slack end of the spanning member 112 is cut and removed.

FIG. 19F is a bottom view of the panel 102 of FIG. 19D and the two mounting clips 1300 of FIG. 19A where the spanning member 112 is tightened and wires 110 from junction boxes 108 of the panel 102 are attached to the spanning member 112, according to various embodiments. In some embodiments, the wires 110 are wrapped around the spanning member 112. In other embodiments, zip ties, cable hangers, etc. are used to secure the wires 110 to the spanning member 112.

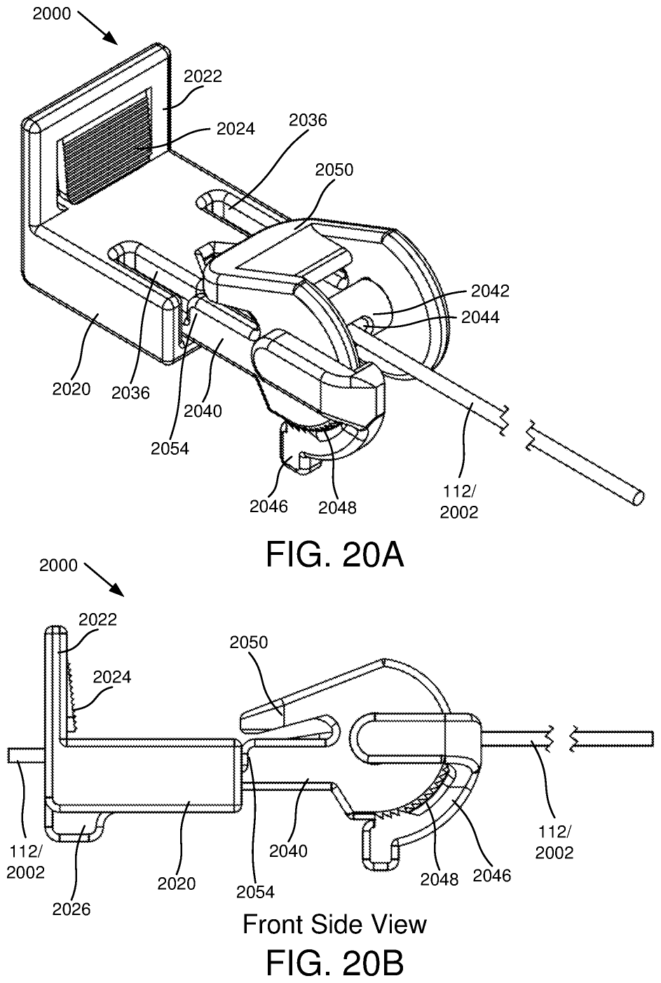

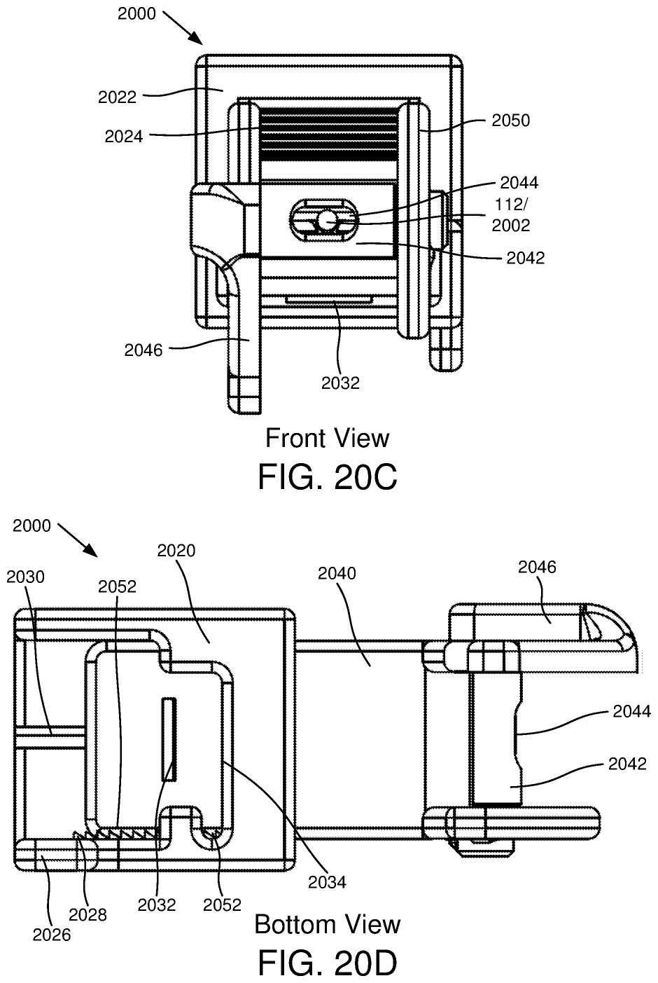

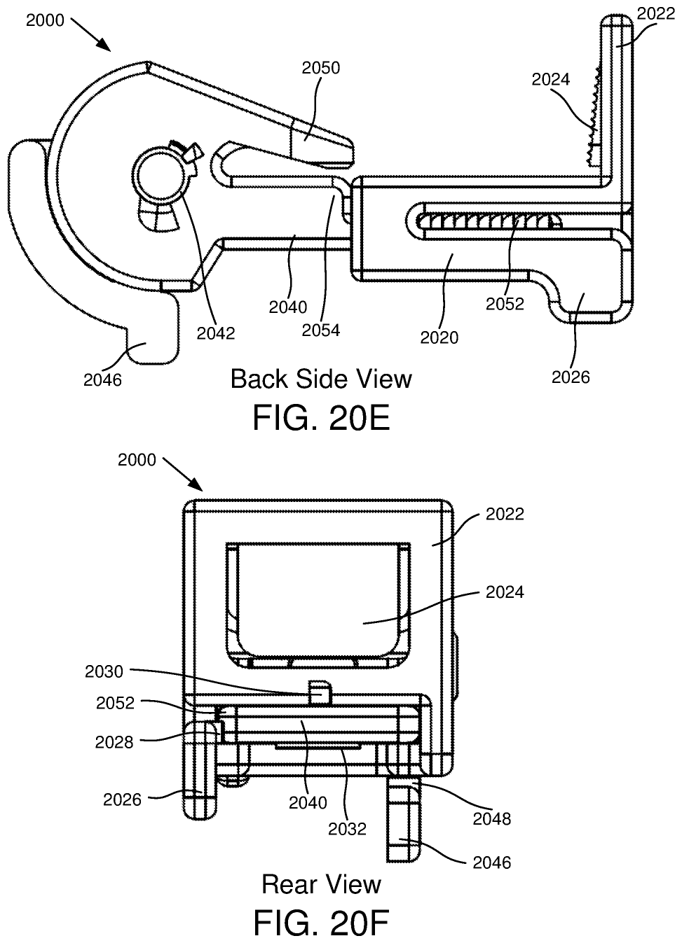

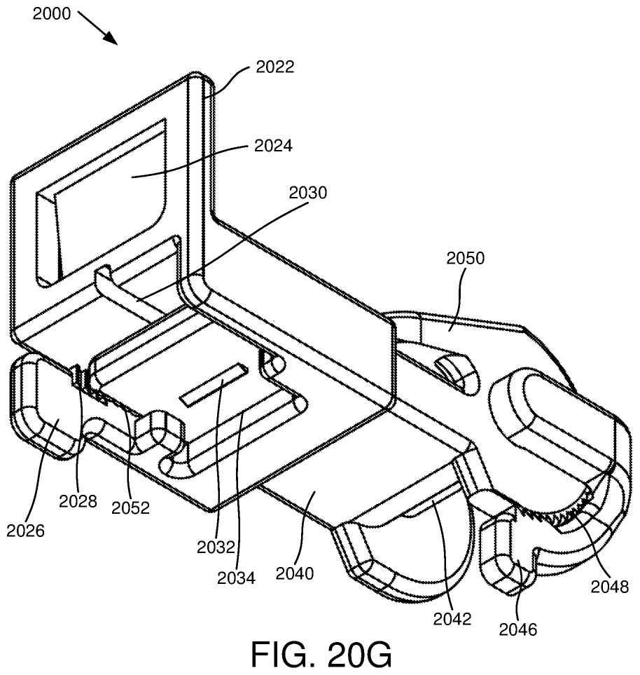

FIG. 20A is a perspective view, FIG. 20B is a side view, FIG. 20C is a front view, FIG. 20D is a bottom view, FIG. 20E is a back side view, FIG. 20F is a rear view, and FIG. 20G is a bottom perspective view of another mounting clip 2000 for securing a spanning member 112 in the form of a cable 2002 to a frame 104 of a panel 102, according to various embodiments. The mounting clip 2000 does not include a roller, but instead includes a cable tensioner 2042 in the form of a rotating cylinder with a cable opening 2044 where the cable 2002 extends through the cable opening 2044. The cable tensioner 2042 is part of an inner clip 2040 that inserts into an outer clip 1340.

The spanning member 112 in the form of a cable 2002 extends through the cable opening 2044 in the inner clip 2040 and the outer clip 2020. A cable tensioner arm 2046 rotates the cable tensioner 2042 to secure the cable 2002 at a particular point after the cable 2002 is tightened or pulled through the mounting clip 2000 a particular amount. Cable locking teeth 2048 hold the cable tensioner arm 2046 in place once rotated enough to secure the cable 2002. The cable 2002 is secured by the cable tensioner 2042 as edges of the cable opening 2044 press against the cable 2002.

The inner clip 2040 includes a frame clip 2050 that is substantially similar to the frame clip 1322 of the mounting clip 1300 described above and functions to loop over an edge of a horizontal portion 1702 of a frame 104. The outer clip 2020 includes a frame stop 2022 that is substantially similar to the frame stop 1352 of the mounting clip 1300 described above. The frame stop 2022 also includes a tensioner arm 2024, which is substantially similar to the tensioner arm 1354 of the mounting clip 1300 described above.

In some embodiments, the tensioner arm 2024 of the mounting clip 2000 of FIGS. 20A-G includes horizontal ridges, which function to help prevent the tensioner arm 2024 from sliding up and down. Likewise, the tensioner arm 1354 the mounting clip 1300 described above may also include horizontal ridges. In some embodiments, the horizontal ridges are formed from material making up the tensioner arms 2024, 1354. In other embodiments, the horizontal ridges are another material, such as rubber, plastic, or other substance that increases resistance of the tensioner arm 2024, 1354.

In some embodiments, the inner clip 2040 includes locking teeth 2052 and the outer clip 2020 includes opposing teeth 2028 that engage each other along a side of the mounting clip 2000. A release arm 2026 flexes outward to release the opposing teeth from the locking teeth 2052, and function similar to the locking teeth 1358 and opposing teeth 1328 of the mounting clip 1300 described above. The inner clip 2040 includes a retainer tooth 2032 that catches on an edge 2034 of an opening in the bottom of the outer clip 2020 where the inner clip 2040 is inserted. The retainer tooth 2032 operates similar to the retainer tooth 1360 of the mounting clip 1300 described above and prevents the inner clip 2040 from moving outward past a certain point with respect to the outer clip 2020. The mounting clip 2000 includes a cable channel 2030 extending through the mounting clip 2000 similar to the spanning member channel 1348 of the mounting clip 1300 described above.

In some embodiments, the inner clip 2040 includes a vertical lip 2054 and the outer clip 2020 includes a slot 2036 with an end that stops the inner clip 2040 from moving inward past a particular point. In the embodiments depicted in FIGS. 20A-G, the inner clip 2040 includes two vertical lips 2054, one on each side, and the outer clip 2020 includes two slots 2036 that include an end.

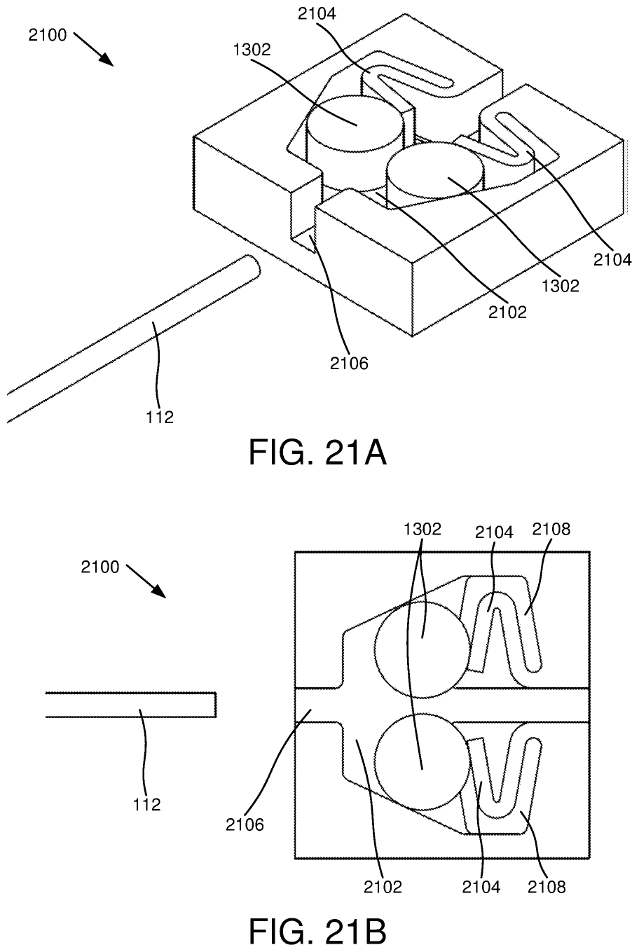

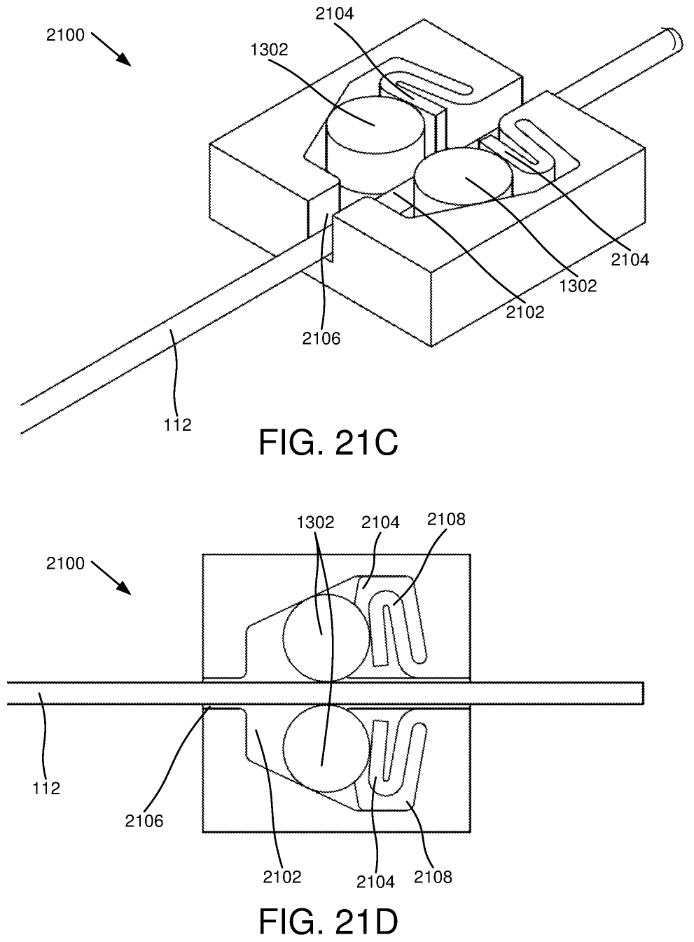

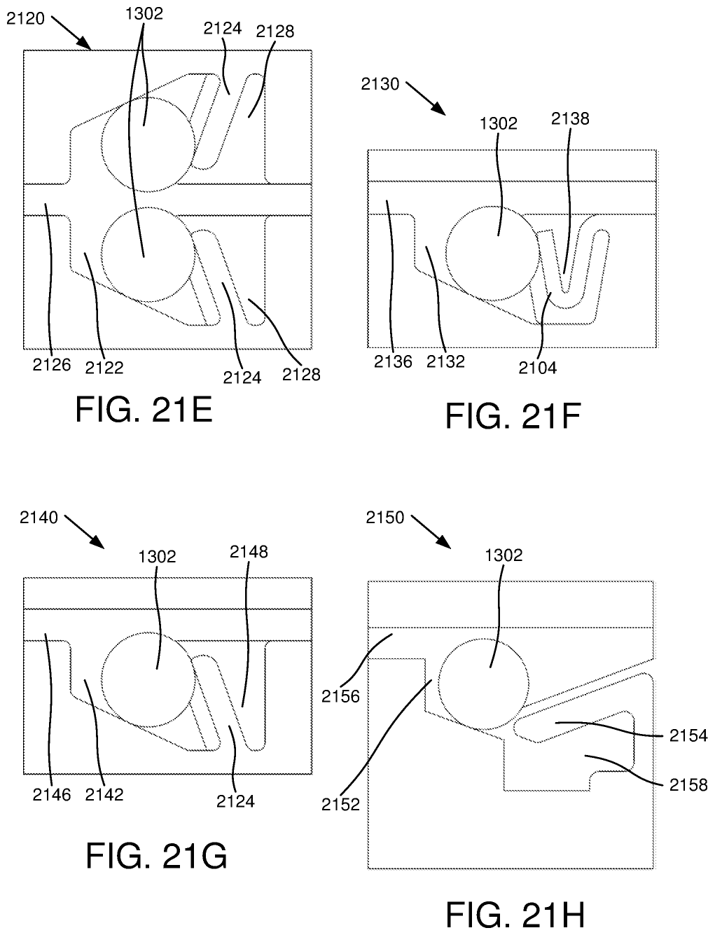

FIG. 21A is a partial perspective view and FIG. 21B is a partial top view of a portion of a mounting clip 2100 with a roller compartment 2102 with a first type of spring prior to insertion of a spanning member 112, according to various embodiments. The partial views are of a portion of a roller compartment 2102 of a mounting clip, such as the roller compartment 1342 of the mounting clip 1300 described above in relation to FIGS. 13A-F. 14A-G, 15A-F. 16A-F, 17A-C. 18A-E and 19A-F. The rollers 1302 are substantially similar to those described in relation to the mounting clip 1300 described above. The spanning member 112 is also substantially similar to those described above. The portion of the mounting clip 2100 also includes a spanning member channel 2106, which is similar to the spanning member channel 1348 described above.

In the embodiments of FIGS. 21A and 21B, the roller compartment 2102 includes two rollers 1302 and also includes two first springs 2104 that are a first type of spring. (Other spring types are described below with regards to FIGS. 21E-H.) In some embodiments, the first springs 2104 are formed during manufacturing of the mounting clip and roller compartment 2102. In the embodiments, the first springs 2104 are made of a same material as the mounting clip and/or outer clip, such as the outer clip 1340 described above. In some embodiments, the first springs 2104 are made of a molded plastic, polymer, or the like. In other embodiments, the first springs 2104 are formed separately and are then inserted into the roller compartment 2102. In the embodiments, the first springs 2104 are made from a stamped metal, wire form, etc. and are then inserted into the roller compartment 2102, for example in a slot, groove, etc. in the roller compartment 2102. One of skill in the art will recognize other ways to create and/or install the first springs 2104.

FIG. 21C is a partial perspective view and FIG. 21D is a partial top view of the portion of a mounting clip 2100 with the roller compartment 2102 of FIG. 21A with the first springs 2104 compressed after insertion of a spanning member 112, according to various embodiments. As the spanning member 112 is inserted, the spanning member 112 contacts the rollers 1302, which are moved towards the first springs 2104 and compress the first springs 2104. Beneficially, the first springs 2104 hold the rollers 1302 in a position so that the rollers 1302 are not relying on gravity or by being moved by the spanning member 112 to be moved into position. Having the rollers 1302 held in position, in some embodiments, decreases lash and allows for one locking mechanism to accept different diameters of the spanning member 112. In some examples, the spanning member 112 may be a cable and may have a diameter of 1.5 millimeters or a diameter of 2.0 millimeters. In the embodiments, the spanning member channel 2106 may be larger than some spanning members 112 that may be used.

The roller compartment 2102, in some embodiments, includes an open section 2108 below the first springs 2104, which may be used to access the first springs 2104 with a release tool (not shown) or other tools, such as screw drivers, needle nose pliers, etc. In various embodiments, all or a portion of the first springs 2104 are accessible through the open section 2108.

FIG. 21E is a partial top view of a portion of a mounting clip 2120 with a roller compartment 2122 with a second type of spring (second springs 2124), according to various embodiments. In the embodiments, the portion of the mounting clip 2120 includes a roller compartment 2122, a spanning member channel 2126, and rollers 1302 similar to those described above. The second springs 2124 are straight and, in some embodiments, are simpler to make than the first springs 2104 described above. The second springs 2124, in some embodiments, have less design freedom than the first springs 2104 and may be thinner or stiffer than the first springs 2104. In some embodiment, the second springs 2124 are exposed with an open section 2128 under all or a portion of the second springs 2124.

FIG. 21F is a partial top view of a portion of a mounting clip 2130 with roller compartment 2132 with a single roller 1302 with the first type of spring (first spring 2104), according to various embodiments. In the embodiments, the portion of the mounting clip 2130 includes a roller compartment 2132, a spanning member channel 2136, and roller 1302 similar to those described above, but there is only a single roller 1302 and a single first spring 2104. Where only a single roller 1302 and single first spring 2104 is used, in some embodiments, the first spring 2104 has a different spring force than the two first springs 2104 described in relation to the portion of the mounting clip 2100 of FIGS. 21A-D. As with the portion of the mounting clip 2100 of FIGS. 21A-D, an open section 2138 is below all or a portion of the first spring 2104.

FIG. 21G is a partial top view of a portion of a mounting clip 2140 with roller compartment 2142 with a single roller 1302 with the second type of spring 2124, according to various embodiments. In the embodiments, the portion of the mounting clip 2140 includes a roller compartment 2142, a spanning member channel 2146, and roller 1302 similar to those described above in relation to FIG. 21E, but there is only a single roller 1302 and a single second spring 2124. Where only a single roller 1302 and single second spring 2124 is used, in some embodiments, the second spring 2124 has a different spring force than the two second springs 2124 described in relation to the portion of the mounting clip 2120 of FIG. 21E. As with the portion of the mounting clip 2140 of FIG. 21G, an open section 2148 is below all or a portion of the second spring 2124.

With a single roller 1302, an advantage of having a spring (e.g., first spring 2104 or second spring 2124) is that the angle θ of the angled sides (see angled sides 1344 of FIG. 15B) can be steeper than described above. Where the optimum angle described above is around 20 degrees without a spring, the angle θ may be in the 30 degree range or higher due to the pressure exerted by the spring on the roller 1302 to maintain traction. The increased slope, in some embodiments, decreases lash, which is beneficial. Thus, including a spring, such as the first spring 2104 or second spring 2124, beneficially allows for a higher slope of the angled sides of the roller compartment 2132, 2142.

FIG. 21H is a partial top view of a portion of a mounting clip 2150 with roller compartment 2152 with a single roller 1302 with a third type of spring (third spring 2154), according to various embodiments. In the embodiments, the portion of the mounting clip 2150 includes a roller compartment 2152, a spanning member channel 2156, and roller 1302 similar to those described above in relation to FIGS. 21A-G and includes only a single roller 1302 and a single third spring 2154. The portion of the mounting clip 2150 of FIG. 21H includes an open section 2158 is below all or a portion of the third spring 2154. In the embodiments of FIGS. 21H, the first direction 1306 and the second direction 1308 are reversed and a spanning member 112 moving left-to-right will jamb the roller 1302 against the third spring 1854 while the spanning member 112 moving right-to-left will move freely.

FIG. 22 is a perspective view of (a) a roller 2200 with a knurled pattern with raised areas 2202 with divots, (b) a roller 2201 with raised areas 2202 with a flat top, and (c) a roller 2220 with parallel ridges 2222, according to various embodiments. In some embodiments, the rollers 2200, 2201 are similar to the rollers 1302 described above.

The rollers 2200, 2201 include raised areas 2202 and valleys 2204 between the raised areas 2202. In some embodiments, the valleys 2204 are in straight lines or semi-straight lines. In other embodiments, the valleys 2204 are perpendicular and the raised areas 2202 have a base that is square. In other embodiments, the valleys 2204 are angled so that the raised areas 2202 have a diamond shape. In some embodiments, the valleys 2204 are positioned at about 45 degrees with respect to a circumference of the knurled rollers 2200, 2201. In other embodiments, the valleys 2204 are aligned with and perpendicular to the circumference of the knurled rollers 2200, 2201.

In some embodiments, the raised areas 2202 are arranged in a direction perpendicular to the circumference of the knurled rollers 2200, 2201. In other embodiments, the raised areas 2202 are arranged in a direction parallel to the valleys 2204. In FIG. 22, the raised areas 2202 and valleys 2204 are approximately 45 degrees with respect to the circumference of the knurled rollers 2200, 2201, but are not exactly 45 degrees.

A knurl-to-knurl distance 2206 between raised areas 2202 in the direction substantially perpendicular to the circumference of the knurled rollers 2200, 2201 is depicted. In some embodiments, the knurl-to-knurl distance 2206 is selected to match or substantially match the ridge-to-ridge distance of the spanning member 112 as a cable to allow ridges of the cable to fit between the raised areas 2202 of the knurled rollers 2200, 2201. In other embodiments, the raised areas 2202 are rounded.

FIG. 22(c) includes a roller 2220 with ridges 2222 that are parallel to each other and perpendicular to a circumference of the roller 2222. The roller 2220 has valleys 2224 between the ridges 2222. The roller 2220 of FIG. 22(c), in some embodiments, is effective at reducing lash and maintaining a tight grip on the spanning member 112. In various embodiments, spacing of the ridges 2222, height of the ridges 2222, etc. is chosen to optimize a holding strength of a spanning member 112 without damaging the spanning member 112.

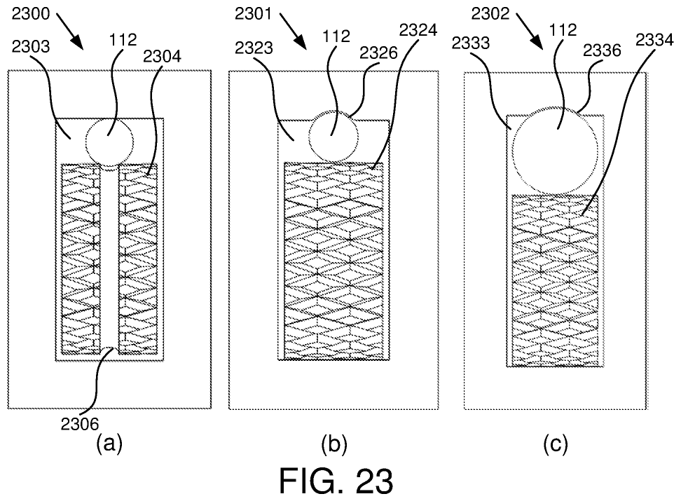

FIG. 23 is a side section view of (a) a portion of a mounting clip 2300 with a roller compartment 2303 with a roller 2304 with a center channel 2306, (b) a portion of a mounting clip 2301 with a roller compartment 2323 with a roller 2304 with a smaller spanning member 112, and (c) a portion of a mounting clip 2302 with a roller compartment 2333 with a roller 2334 with a larger spanning member 112. The portions of mounting clips 2300, 2301, 2302 of FIGS. 23(a)-(c), in some embodiments, are useful for the single roller embodiments of FIGS. 21F, 21G, and 21H.

The portion of the mounting clip 2300 of FIG. 23(a) includes a roller compartment 2303 without a channel, groove, etc. on a side where the spanning member 112 contacts the roller compartment 2303. To maintain the spanning member 112 in the middle of the roller 2304, the roller 2304 includes a center channel 2306 that allows an appropriately sized roller 2304 to rest in the center channel 2306. With a spring, such as the springs 2104, 2124, 2154 of FIGS. 21F-H, in some embodiments, the spanning member 112 remains in the center channel 2306, which is centered on the roller 2304. In other embodiments, the roller 2304 with a center channel 2306 is used in applications with two rollers, such as the mounting clip 1300 described above.

FIG. 23(b) includes a portion of a mounting clip 2301 with a roller compartment 2323 with a roller 2324 similar to the rollers 1302 described above and with an upper channel 2326 shaped to retain the spanning member 112 in a center of the roller 2324. Likewise, FIG. 23(c) includes a portion of a mounting clip 2302 with a roller compartment 2333 with a roller 2334 similar to the rollers 1302 described above and with a larger upper channel 2336 shaped to retain a larger spanning member 112 in a center of the roller 2334. Where a spring are used in a mounting clip (e.g., 1300), such as the springs 2104, 2144, 2154 of FIGS. 21F-H, spanning members 112 of different sizes may be used. The larger upper channel 2336 of FIG. 23(c), in some embodiments, maintains the spanning member 112 in the center of the roller 2334 for spanning members 112 of different sizes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a mounting clip comprising an outer clip and an inner clip, the outer clip and inner clip operable to clamp onto a frame; and
a locking mechanism within the mounting clip configured to resist movement of a spanning member extending through the mounting clip in a first direction and to allow movement of the spanning member in a second direction opposite the first direction, the locking mechanism comprising one or more rollers configured to wedge against the spanning member moving in the first direction.

2. The apparatus of claim 1, wherein the outer clip and inner clip clamp onto the frame in response to the outer clip sliding into the inner clip to engage a side of the frame.

3. The apparatus of claim 2, wherein the side of the frame comprises a horizontal portion and a vertical portion coupled to the horizontal portion, wherein:
the inner clip comprises a frame clip configured to engage an edge of the horizontal portion of the frame; and
the outer clip comprises a frame stop configured to engage the vertical portion of the frame,
wherein sliding the outer clip towards the inner clip with the frame clip over the horizontal portion of the frame and the frame stop against the vertical portion of the frame secures the mounting clip to the frame.

4. The apparatus of claim 1, wherein the locking mechanism comprises a roller compartment with two rollers positioned on either side of the spanning member, the roller compartment comprising an angled side adjacent to each of the two rollers, the angled sides angled to narrow in a direction towards the inner clip in the second direction.

5. The apparatus of claim 4, wherein an angle of each of the angled sides is in a range of 10 degrees to 35 degrees.

6. The apparatus of claim 5, wherein the angle of each of the angled sides is in a range of 27 degrees to 33 degrees.

7. The apparatus of claim 4, wherein the mounting clip comprises a channel that extends through the roller compartment and positioned to maintain the spanning member between the two rollers.

8. The apparatus of claim 1, wherein the spanning member is a cable comprising an exterior surface with ridges and valleys and wherein a distance between two adjacent raised areas measured in a direction perpendicular to a circumference of a roller of the one or more rollers is selected to allow a ridge of the cable to fit between the two adjacent raised areas.

9. The apparatus of claim 1, wherein the one or more rollers comprise two textured rollers comprising a textured outer surface in contact with the spanning member.

10. The apparatus of claim 9, wherein a texture pattern of the two textured rollers comprises a rough surface, an irregular surface, and/or a knurled pattern, the knurled pattern comprising raised areas with one of a rounded top, a flat top, and a top with a divot.

11. The apparatus of claim 1, wherein the outer clip comprises locking teeth, the locking teeth arranged in a row in a direction that the outer clip slides through the inner clip, and wherein the inner clip comprises opposing teeth positioned to mate with the locking teeth and to oppose sliding the outer clip away from the inner clip.

12. The apparatus of claim 11, wherein the opposing teeth are mounted on a clip release lever configured to disconnect the opposing teeth from the locking teeth upon application of a force on the clip release lever.

13. The apparatus of claim 11, wherein the outer clip comprises a frame stop configured to engage a vertical portion of the frame and wherein the frame stop further comprises a tensioner arm oriented towards the inner clip, the tensioner arm configured to provide a spring force opposing movement of the frame stop towards the frame, wherein a range of the tensioner arm is greater than a distance between two adjacent locking teeth of the locking teeth of the outer clip.

14. The apparatus of claim 1, wherein one of:
the inner clip comprises a retainer channel and the outer clip comprises a retainer tooth positioned in the retainer channel; and
the outer clip comprises a retainer channel and the inner clip comprises a retainer tooth positioned in the retainer channel,
wherein one or both ends of the retainer channel are positioned to limit travel of the outer clip within the inner clip to maintain the one or more rollers within a roller compartment.

15. The apparatus of claim 1, wherein the spanning member comprises a cable, the cable comprises one of a stainless-steel cable and a galvanized steel cable, and/or wherein the cable comprises a coating and the coating comprises a plastic, a polymer, and/or a rubber.

16. The apparatus of claim 1, further comprising a slack management opening integral to the mounting clip and configured to hold a portion of the spanning member extending from the mounting clip.

17. The apparatus of claim 16, wherein the slack management opening comprises a gap between the outer clip and the inner clip running in a direction that the outer clip slides with respect to the inner clip.

18. The apparatus of claim 1, wherein the locking mechanism comprises a roller compartment comprising the one or more rollers and wherein the roller compartment comprises a spring for each of the one or more rollers configured to exert a spring force on the roller, the spring arranged to exert the spring force in the first direction.

19. A system comprising:
a first mounting clip and a second mounting clip; and
a spanning member positioned between the first mounting clip and the second mounting clip,
wherein each mounting clip comprises:
an outer clip and an inner clip, the outer clip and inner clip of the first mounting clip operable to clamp onto a first side of a frame and the outer clip and inner clip of the second mounting clip operable to clamp onto a second side of the frame; and
a locking mechanism within each mounting clip configured to resist movement of the spanning member extending through the mounting clip in a first direction towards the inner clip of the mounting clip and to allow movement of the spanning member in a second direction opposite the first direction, the locking mechanism comprising one or more textured rollers configured to wedge against the spanning member moving in the first direction.
wherein the first mounting clip and the second mounting clip are positionable on the frame to tighten the spanning member between the first mounting clip and second mounting clip.

20. The system of claim 19, wherein the frame is a frame of an electrical panel and wherein the spanning member is a cable configured to support wiring of the electrical panel.

21. An apparatus comprising:
a mounting clip comprising an outer clip and an inner clip, the outer clip and inner clip operable to clamp onto a frame, the frame comprising a horizontal portion and a vertical portion coupled to the horizontal portion, wherein:
the inner clip comprises a frame clip configured to engage an edge of the horizontal portion of the frame;
the outer clip comprises a frame stop configured to engage the vertical portion of the frame, wherein sliding the outer clip towards the inner clip with the frame clip over the horizontal portion of the frame and the frame stop against the vertical portion of the frame secures the mounting clip to the frame; and
the outer clip comprising locking teeth, the locking teeth arranged in a row in a direction that the outer clip slides through the inner clip, and wherein the inner clip comprises opposing teeth positioned to mate with the locking teeth and to oppose sliding the outer clip away from the inner clip;
a cable; and
a locking mechanism within the mounting clip configured to resist movement of the cable extending through the mounting clip in a first direction and to allow movement of the cable in a second direction opposite the first direction, the locking mechanism comprising a roller compartment with two textured rollers positioned on either side of the cable configured to wedge against the cable moving in the first direction, the roller compartment comprising an angled side adjacent to each of the two textured rollers, the angled sides angled to narrow in a direction towards the inner clip in the second direction, wherein an angle of each of the angled sides is in a range of 10 degrees to 35 degrees.

22. The apparatus of claim 21, wherein the cable comprises an exterior surface with ridges and valleys and wherein a distance between two adjacent raised areas measured in a direction perpendicular to a circumference of the textured roller is selected to allow a ridge of the cable to fit between the two adjacent raised areas.
